(19) United States
(12) Patent Application Publication
(10) Pub. No.: US 2024/0110344 A1
(43) Pub. Date: Apr. 4, 2024

(54) VEHICLE AND METHOD

(71) Applicant: A2E INDUSTRIES LIMITED, Manchester (GB)

(72) Inventors: Alec BURNS, Manchester (GB); Paolo PAOLETTI, Manchester (GB); Sebastiano FICHERA, Manchester (GB)

(21) Appl. No.: 17/933,686

(22) Filed: Sep. 20, 2022

(51) Int. Cl. E01C 23/09; B62D 55/02; B62D 55/06; E01C 7/14; E01C 7/18; E01C 7/30; E01C 11/00; G05D 1/02

(52) U.S. Cl. CPC E01C 23/096; B62D 55/02; B62D 55/06; E01C 7/147; E01C 7/187; E01C 7/30; E01C 11/005; E01C 23/0926; G05D 1/0212; G05D 1/0231

(57) ABSTRACT

A vehicle 1 is described. The vehicle 1 is preferably an unmanned and/or autonomous vehicle, for example a robot. The vehicle 1 comprises: a propulsion system 10, arranged to propel the vehicle 1 on a surface S, comprising a set of wheels 11 including a first wheel 11A and/or a set of tracks 12 including a first track 12A; a set of sensors 40, including a first sensor 40A, arranged to sense a first deposition target T1 of a set of deposition targets T in the surface S and to transmit a first signal 41, in response to sensing the first deposition target T1; optionally, a deposition apparatus 20 for depositing a material M on and/or in the first deposition target T; and a controller 30 arranged to receive the first signal 41 transmitted by the first sensor 40A and to control the propulsion system 10 and/or the deposition apparatus 20, based, at least in part, on the received first signal.

### FIELD

The present invention relates to a vehicle for, and to a method of, sensing deposition targets in surfaces for depositing material thereon and/or therein.

### BACKGROUND TO THE INVENTION

In the UK, more than 2 million potholes in roads are repaired annually at a cost of about £120 million. However, damage to vehicles caused by potholes is estimated to cost in excess of £1 billion annually in the UK. In addition, the number of reported cyclists serious and fatal injuries in the UK where poor defective road surface is reported as a contributory factor has increased linearly between 2007 and 2017 from 17 to 64 cyclists.

Typically, a pothole is hole or a depression in a road surface that results from gradual damage caused by traffic and/or weather. A pothole may be defined more specifically as a cavity in a road, footpath or cycle route, having a depth of at least 25 mm or at least 40 mm, though potholes are typically only repaired when reaching a depth of at least 60 mm. Cost of repair and potential damage to vehicles increases with depth. Nevertheless, around 90% of potholes are in the top wearing course. Earlier remediation may reduce cost of repair and potential damage to vehicles.

Potholes are typically identified by members of the public and reported to the relevant local highway authority. A reported pothole may be repaired when characterised as meeting the local highway authority's intervention criteria, typically within a target of 20 days. Pothole repair treatments are almost invariably manual and include patching with hot asphalt, mastic or bitumen-based material, thermal road repair, in situ thermal recycling, spray injection patching and cold applied instant material.

Hence, there is a need to improve identification and/or repair of potholes.

### SUMMARY OF THE INVENTION

It is one aim of the present invention, amongst others, to provide a vehicle which at least partially obviates or mitigates at least some of the disadvantages of the prior art, whether identified herein or elsewhere. For instance, it is an aim of embodiments of the invention to provide a vehicle for better identifying potholes and/or repairing potholes.

A first aspect provides a vehicle, preferably an unmanned and/or autonomous vehicle, for example a robot, the vehicle comprising:
a propulsion system, arranged to propel the vehicle on a surface, comprising a set of wheels including a first wheel and/or a set of tracks including a first track;
a set of sensors, including a first sensor, arranged to sense a first deposition target of a set of deposition targets in the surface and to transmit a first signal, in response to sensing the first deposition target;
optionally, a deposition apparatus for depositing a material on and/or in the first deposition target; and
a controller arranged to receive the first signal transmitted by the first sensor and to control the propulsion system and/or the deposition apparatus, based, at least in part, on the received first signal.

A second aspect provides a method of controlling a vehicle according to the first aspect to sense deposition targets and optionally, to deposit a material thereon and/or therein, the method comprising:
sensing a first deposition target of a set of deposition targets and transmitting a first signal, in response to sensing the first deposition target;
controlling the propulsion system, based, at least in part, on the received first signal; and
optionally, depositing at least some of the material on and/or in the first deposition target, based, at least in part, on the received first signal.

A third aspect provides a method of remediating damage, such as a crack or a pothole, to a thoroughfare, according to the second aspect.

A fourth aspect provides a vehicle, preferably an unmanned and/or autonomous vehicle, for example a robot, the vehicle comprising:
a propulsion system, arranged to propel the vehicle, comprising a set of wheels including a first wheel and/or a set of tracks including a first track;
a deposition apparatus for depositing a foam comprising a polymeric composition; and
a controller arranged to control the deposition apparatus and optionally, the propulsion system; wherein the deposition apparatus comprises:
a set of reservoirs, including a first reservoir and a second reservoir arranged to receive therein a first component and a second component of the polymeric composition, respectively; optionally a set of pumps, including a first pump and a second pump arranged to pump the first component and the second component from the first reservoir and the second reservoir, respectively;
a blending chamber in fluid communication with the set of reservoirs via a set of inlet passageways, including a first inlet passageway and a second inlet passageway, wherein the blending chamber is arranged to blend the first component and the second component therein to provide a precursor of the polymeric composition; and
a set of deposition nozzles in fluid communication with the blending chamber via a set of outlet passageways including a first outlet passageway, the set of deposition nozzles including a first deposition nozzle comprising a static mixer arranged to mix the precursor to generate the foam, at least in part, therefrom.

A fifth aspect provides a method of controlling a vehicle according to the fourth aspect to deposit a foam comprising a polymeric composition, the method comprising:
blending, using the blending chamber, the first component and the second component of the polymeric composition to provide the precursor of the polymeric composition;
generating the foam, at least in part, by mixing, using the static mixer included in the first deposition nozzle, the precursor; and
depositing the foam, at least in part, via the first deposition nozzle.

A sixth aspect provides a deposition apparatus for depositing a foam comprising a polymeric composition, the deposition apparatus comprising:
a set of reservoirs, including a first reservoir and a second reservoir arranged to receive therein a first component and a second component of the polymeric composition, respectively;
optionally a set of pumps, including a first pump and a second pump arranged to pump the first component and the second component from the first reservoir and the second reservoir, respectively;
a blending chamber in fluid communication with the set of reservoirs via a set of inlet passageways, including a first inlet passageway and a second inlet passageway, wherein the blending chamber is arranged to blend the first component and the second component therein to provide a precursor of the polymeric composition; and
a set of deposition nozzles in fluid communication with the blending chamber via a set of outlet passageways including a first outlet passageway, the set of deposition nozzles including a first deposition nozzle comprising a static mixer arranged to mix the precursor to generate the foam, at least in part, therefrom.

A seventh aspect provides a method of depositing a foam comprising a polymeric composition, the method comprising:
blending, using a blending chamber, a first component and a second component of the polymeric composition to provide a precursor of the polymeric composition;
generating the foam, at least in part, by mixing, using a static mixer included in a first deposition nozzle, the precursor; and
depositing the foam, at least in part, via the first deposition nozzle.

A eighth aspect provides use of a blending chamber to blend a first component and a second component of a polymeric composition to provide a precursor of the polymeric composition prior to generating a foam, at least in part, from the precursor using a static mixer.

### DETAILED DESCRIPTION OF THE INVENTION

According to the present invention there is provided a vehicle, as set forth in the appended claims. Also provided is a method. Other features of the invention will be apparent from the dependent claims, and the description that follows.

Vehicle

The first aspect provides a vehicle, preferably an unmanned and/or autonomous vehicle, for example a robot, the vehicle comprising:
a propulsion system, arranged to propel the vehicle on a surface, comprising a set of wheels including a first wheel and/or a set of tracks including a first track;
a set of sensors, including a first sensor, arranged to sense a first deposition target of a set of deposition targets in the surface and to transmit a first signal, in response to sensing the first deposition target;
optionally, a deposition apparatus for depositing a material on and/or in the first deposition target; and
a controller arranged to receive the first signal transmitted by the first sensor and to control the propulsion system and/or the deposition apparatus, based, at least in part, on the received first signal.

Vehicle

The first aspect provides the vehicle, preferably an unmanned and/or autonomous vehicle, for example a robot.

In one example, the vehicle is a land craft. In one example, the land craft is a two-wheeled vehicle such as a scooter or a motorbike, a three-wheeled vehicle, a four-wheeled vehicle such as an automobile, a van, a bus, a truck, a forklift truck, a military vehicle, or a vehicle having more than two axles, such as a lorry, a tram or a train. In one example, the land craft is a tracked vehicle, having continuous tracks, such as a recovery or rescue vehicle, a bulldozer, a tractor, a military vehicle such as a tank.

The vehicle is preferably an unmanned and/or autonomous vehicle for example a robot. Generally, an unmanned vehicle (also known as an uncrewed vehicle) is a vehicle without a person on board. An unmanned vehicle can either be a remote controlled vehicle (also known as a remote guided vehicle) or an autonomous vehicle, capable of sensing its environment and navigating autonomously. Unmanned vehicles include unmanned ground vehicles (UGV), such as autonomous cars. For example, autonomous cars (also known as self-driving cars) combine a variety of sensors to perceive their surroundings, such as RADAR, LIDAR, SONAR, GPS, odometry and inertial measurement units, while advanced control systems interpret the sensory information to identify appropriate navigation paths, as well as obstacles.

In one preferred example, the vehicle is a robot, such as a wheeled and/or a tracked robot. Generally, robots are machines, especially programmable by computers, capable of carrying out complex series of actions automatically. Robots may be controlled by external control devices or control may be embedded (i.e. autonomous robots).

In one example, the vehicle is an existing vehicle and the set of sensors, the controller and/or the deposition apparatus are provided therefor, as a retrofit for example.

Surface

It should be understood that the surface is movement of vehicles and/or people thereupon, such as a roadway or a walkway. In one example, the surface comprises and/or is a road, a footpath or a cycle route. In one example, the surface comprises and/or is a car park, a pedestrianised thoroughfare, a pavement, a runway, the sportsground or a hall.

Typically, such surfaces are formed from materials including: asphalt (specifically, asphalt concrete) including rubberised asphalt; concrete including jointed plane, jointed reinforced and continuously reinforced concrete; and/or a composite combining a Portland cement concrete sublayer and an asphalt overlay. Other materials include gravel, pavers, brick, cobblestone, sett, macadam and/or tarmac. Plastics road surfacing material typically use a composite comprising a mixture of a polymeric composition comprising a polymer and bitumen, for example, such as based on polyethylene terephthalate (PET or PETE), polypropylene (PP), and/or high- and/or low-density polyethylene (HDPE and/or LDPE), together with bitumen. After mixing, the mixture is laid as one would with regular asphalt concrete. Examples include MR6, MR8, MR10 available from MacRebur Ltd (Lockerbie, UK). Other materials are known.

Deposition Target

It should be understood that a deposition target is a defect in the surface, for example a cavity, a concavity, a void, a crack, a fissure, a void or a pothole. Road surface defects may include potholes, service deterioration, edge failure, cracks, crazing, writing and subsidence. A pothole may be defined as a cavity in a road, footpath or cycle route, having a depth of at least 25 mm or at least 40 mm, as discussed previously.

Typically, such deposition targets result from deterioration of the surface, due to loading, weather and/or ground movement. For example, road surfaces such as those containing bitumen as a binder embrittle over time and crack under loading. For example, permeation of water into surfaces and subsequent freezing and hence expansion thereof causes the surfaces to fail. For example, drought may cause shrinkage of the underlying ground, causing transverse and/or longitudinal cracking of the surfaces.

In one example, a first dimension, for example a depth, of the first deposition target is in a range from 5 mm to 300 mm, preferably in a range from 10 mm to 150 mm, more preferably in a range from 15 mm to 75 mm, most preferably in a range from 20 mm to 40 mm. By sensing relatively shallower deposition targets, a cost of remediation and/or a risk of damage to users is reduced.

In one example, a second dimension, for example a width, of the first deposition target is in a range from 5 mm to 600 mm, preferably in a range from 10 mm to 300 mm, more preferably in a range from 15 mm to 150 mm, most preferably in a range from 20 mm to 75 mm. By sensing relatively narrower deposition targets, a cost of remediation and/or a risk of damage to users is reduced.

In one example, a third dimension, for example a length, of the first deposition target is in a range from 5 mm to 1200 mm, preferably in a range from 10 mm to 600 mm, more preferably in a range from 15 mm to 300 mm, most preferably in a range from 20 mm to 150 mm. By sensing relatively shorter deposition targets, a cost of remediation and/or a risk of damage to users is reduced.

In one example, the set of deposition targets includes T deposition targets, including the first deposition target, wherein T is a natural number greater than or equal to 1, for example 1, 2, 3, 4, 5, 6, 7, 8, 9, 10, 50, 100, 200, 500, 1,000, 2,000, 5,000, 10,000 or more. More generally, the set of sensors maybe arranged to sense an unlimited number of deposition targets in the surface and to transmit respective signals in response to sensing the deposition targets.

Propulsion System

The vehicle comprises the propulsion system, arranged to propel the vehicle on the surface, comprising the set of wheels including the first wheel and/or the set of tracks including the first track. In one example, the set of wheels includes N wheels, including the first wheel, wherein N is a natural number greater than or equal to 1, for example 1, 2, 3, 4, 5, 6, 7, 8, 9, 10 or more, preferably 2, 4, 6, or 8. In one example, the set of tracks includes M tracks, including the first track, wherein M is a natural number greater than or equal to 1, for example 1, 2, 3, 4, 5, 6, 7, 8, 9, 10 or more, preferably 2, 4, 6, or 8. In one example, the propulsion system comprises a set of actuators, for example motors and/or engines, including a first actuator, arranged to actuate the set of wheels and/or the set of tracks (for example, by being coupled thereto), and hence propel the vehicle. In one example, the propulsion system comprises a power source, for example a battery, and/or a fuel supply.

Sensors

The vehicle comprises the set of sensors, including the first sensor, arranged to sense the first deposition target of the set of deposition targets in the surface and to transmit the first signal, in response to sensing the first deposition target. In this way, the first deposition target is sensed and the first signal transmitted in response thereto. It should be understood that the first signal corresponds to the first deposition target. In one example, the first signal comprises an image, a location and/or dimensions of the first deposition target.

In one example, the first sensor comprises and/or is an optical sensor, for example an imager and/or a non-contact optical profilometer such as a laser scanner. In this way, an image or a profile of the first deposition target may be acquired by the first sensor. For example, machine vision may be used to identify the first deposition target in the image. For example, a three-dimensional, 3D, shape of the first deposition target may be reconstructed using profiles of the first deposition target, for example by the controller. Dimensions, for example depth, width and/or length, of the first deposition target maybe estimated from the image and/or profiles, for example by the controller. In one example, the imager comprises and/or is a 2D or a 3D imager, such as a 2D or a 3D camera. Suitable 2D and 3D cameras, together with machine vision software, are known. In one example, the non-contact optical profilometer comprises and/or is a 2D or a 3D laser scanner or profiler. Typically, 2D and 3D laser scanners (also known as triangulation sensors) operate on a principle of triangulation. Suitable 2D and 3D laser scanners, together with associated software, are known.

In one example, the set of sensors is arranged to sense the first deposition target after depositing the material therein and/or thereon. In this way, the controller may determine whether additional material must be deposited thereon and/or therein, for example.

Controller

The vehicle comprises the controller arranged to receive the first signal transmitted by the first sensor and to control the propulsion system and/or the deposition apparatus, based, at least in part, on the received first signal. In one example, the controller comprises a processor and a memory and is arranged to control the deposition apparatus and optionally, the propulsion system, using software (i.e. programmatic instructions executed by the processor). In one example, the vehicle comprises a communications (wired and/or wireless) interface for onboard communication and/or communication with external devices, for example for remote-control by a human operator.

In one example, the controller is arranged to control the propulsion system to move the vehicle and to control the deposition apparatus to deposit at least some of the material on and/or in the first deposition target, based, at least in part, on the received first signal, optionally while the vehicle is moving. In this way, the controller may control the propulsion system and/or the deposition apparatus responsive to sensing the first deposition target, for example to slow, stop or change direction of propulsion and/or to start or stop deposition of material.

In one example, the controller is arranged to control the propulsion system to control a speed and/or heading (i.e. direction, bearing, orientation) of the vehicle. In this way, the vehicle may search the surface for deposition targets, locate and/or follow deposition targets, and/or deposit material thereon and/or therein.

In one example, the controller is arranged to control the propulsion system to follow the first deposition target, based, at least in part, on the received first signal. In this way, the first deposition target may be sensed, for example fully, and/or material deposited thereon and/or therein.

In one example, the controller is arranged to control the deposition apparatus to deposit at least some of the material on and/or in the first deposition target, based, at least in part, on the received first signal, while the vehicle is following the first deposition target. In this way, material may be deposited on and/or in the first deposition target along a length and/or a width thereof, for example to fill, such as completely fill, the first deposition target.

In one example, the controller is arranged to control the deposition apparatus to repeatedly deposit at least some of the material on and/or in the first deposition target, based, at least in part, on the received first signal. In this way, relatively deep deposition targets may be filled, for example fully, with the material.

In one example, the controller is arranged to determine a first dimension, for example a depth, a width and/or a length, of the first deposition target, based, at least in part, on the received first signal. In one example, the controller is arranged to determine a volume of the first deposition target, based, at least in part, on the received first signal, for example using the determined first dimension. In this way, a volume of material required to fill the first deposition target may be estimated by the controller.

In one example, the controller is arranged to control the deposition apparatus to deposit at least some of the material on and/or in the first deposition target, based, at least in part, on the determined first dimension. In this way, the deposition apparatus may be controlled to deposit an amount of the material corresponding with the determined first dimension.

In one example, the controller is arranged to control the propulsion system to move the vehicle rearwardly or forwardly and to control the deposition apparatus to deposit at least some of the material on and/or in the first deposition target, based, at least in part, on the received first signal. For example, upon sensing of the first deposition target, the controller may control the propulsion system to slow, stop and/or reverse the vehicle and to deposit the material.

In one example, the controller is arranged to control the propulsion system and/or the deposition apparatus to repeatedly move the vehicle and/or deposit at least some of the material on and/or in the first deposition target. In this way, the vehicle may fill relatively larger deposition targets.

In one example, the controller is arranged to control the propulsion system to move the vehicle forwardly and to control the deposition apparatus to deposit at least some of the material on and/or in the first deposition target, based, at least in part, on the received first signal, optionally while the vehicle moves forwardly. In this way, the first deposition target may be at least partially filled, for example.

In one example, the controller is arranged to control a rate of deposition of material deposited by the deposition apparatus. In this way, relatively larger deposition targets they be filled relatively more quickly, for example.

In one example, the controller is arranged to control a deposition pattern of the material deposited by the deposition apparatus, such as to fill the first deposition target, for example by controlling the deposition apparatus and optionally, the propulsion system, for example synchronously (i.e. in a coordinated manner). In one example, the deposition pattern comprises one or more lines of deposited material. In one example, the deposition pattern comprises one or more points of deposited material, for example defining a matrix of deposited material. In one example, the deposition pattern comprises one or more layers of deposited material.

Deposition Apparatus

The vehicle optionally comprises the deposition apparatus for depositing the material on and/or in the first deposition target. For example, a first vehicle, not comprising a deposition apparatus, may be configured to sense the set of deposition targets and to transmit the information relating thereto to a server and a second vehicle, comprising a deposition apparatus, may be configured to propel the second vehicle and deposit material on and/or in respective deposition targets of the set thereof, in response to the server receiving the information relating thereto.

In one example, the deposition apparatus comprises: a set of reservoirs, including a first reservoir, arranged to receive the material therein; and a set of deposition nozzles, including a first deposition nozzle, in fluid communication with the set of reservoirs via a set of outlet passageways including a first outlet passageway; optionally, a set of extruders, including a first extruder, arranged to urge at least some of the material received in the set of reservoirs through the set of deposition nozzles.

In one example, the deposition apparatus comprises and/or is a gravity-fed deposition apparatus, whereby the material received in the first reservoir is deposited via the first deposition nozzle by flowing under gravity from the first reservoir and through the first passageway to the first deposition nozzle. Gravity feed is suitable for particulate and liquid materials, together with slurries having relatively lower viscosities.

In one example, the deposition apparatus comprises and/or is a pressure-fed deposition apparatus, whereby the material received in the first reservoir is deposited via the first deposition nozzle by being urged from the first reservoir and through the first passageway to the first deposition nozzle, by the first extruder. Pressure feed is suitable for liquids and/or slurries having relatively higher viscosities, for example.

In one example, the first extruder comprises and/or is a piston extruder or a screw extruder. Piston extruders are relatively simple while screw extruders are suitable for liquids and/or slurries having relatively higher viscosities, for example. Suitable piston extruders and screw extruders are known.

In one example, the first deposition nozzle is arranged rearwardly of the first sensor. In this way, in response to sensing the first deposition target by the first sensor, the controller may control the deposition apparatus to deposit at least some of the material thereon and/or therein.

Material

The deposition apparatus is for depositing the material on and/or in the first deposition target, in the surface. As described previously, the surface may be formed from materials including: asphalt (specifically, asphalt concrete) including rubberised asphalt; concrete including jointed plane, jointed reinforced and continuously reinforced concrete; and/or a composite combining a Portland cement concrete sublayer and an asphalt overlay. Other surface materials include gravel, pavers, brick, cobblestone, sett, macadam and/or tarmac. Other surface materials are known. It should be understood that the deposited material is compatible with the surface. In one example, the material comprises and/or is a solid, for example particulate solids such as sand and/or aggregate including chippings and recycled surface material, or relatively larger solids such as bricks or precast concrete slabs, for example. Such particulate solids may be deposited, for example by gravity feeding, in the first deposition target as foundation layer, for example, and may be optionally compacted after deposition. Relatively larger solids may provide a finished surface. In one example, the material comprises a slurry comprising asphalt, such as asphalt concrete, or cement (i.e. a cementitious material). Typically, slurries require curing after pouring (i.e. gravity feeding) and/or extruding (i.e. pressure feeding) into the first deposition target, for example onto a foundation layer, and may provide the finished surface. In one example, the material comprises a liquid, such as asphalt. The viscosities of slurries may be determined and suitable extruded provided. Additionally and/or alternatively, the deposited material may comprise a polymeric composition comprising a polymer, for example for repair of plastics road surfacings and/or a foam, as described with respect to the fourth aspect. For example, the foam may be used as a foundation layer and/or may provide the finished surface, such as for a temporary repair. For example, the foam may be used as a foundation layer and a slurry comprising asphalt, such as asphalt concrete, or cement (i.e. a cementitious material) deposited on the foam foundation layer, after curing thereof.

Transmitter

In one example, the vehicle comprises a transmitter, wherein the controller is arranged to control the transmitter to transmit information, for example respective locations such as GPS coordinates and/or respective dimensions such as the first dimension, relating to the set of deposition targets, for example to a server. In this way, the set of deposition targets may be reported and remediation thereof actioned. For example, a first vehicle may be configured to sense the set of deposition targets and to transmit the information relating thereto to the server and a second vehicle may be configured to propel the second vehicle and deposit material on and/or in respective deposition targets of the set thereof, in response to the server receiving the information relating thereto. In one example, the server is configured to analyse the received information, for example for quality assurance purposes, for predictive maintenance and/or for automated improvement of repair processes, for example using machine learning algorithms.

Machine Tool

In one example, the vehicle comprises a machine tool, for example a mill, a drill or a cutter, arranged to machine, for example mill, drill and/or cut, the surface to redefine, at least in part, the first deposition target. In this way, a shape of the first of the position target may be controlled, for example to improve effectiveness of deposition therein and/or an efficacy of remediation. In one example, the controller is arranged to control the machine tool.

Cleaner

In one example, the vehicle comprises a cleaner, for example an air blower apparatus, a sweeper apparatus and/or a vacuum apparatus, arranged to remove debris, for example damaged surface material, cuttings resulting from machining the surface and/or waste, from the first deposition target. In this way, an effectiveness of deposition therein and/or an efficacy of remediation may be improved since the debris is removed from the first deposition target.

Dryer

In one example, the vehicle comprises a dryer arranged to dry the first deposition target, for example to remove water therefrom. In this way, an efficacy of remediation may be improved.

Compactor

In one example, the vehicle comprises a compactor arranged to compact the deposited material in and/or on the first deposition target. In this way, the deposited material may be compacted or consolidated, thereby improving structural properties thereof and, in turn, and efficacy of remediation.

Heater

In one example, the vehicle comprises a heater arranged to thermally repair the first deposition target and/or cure the deposited material. In this way, an efficacy and/or a speed of remediation may be improved.

Method

The second aspect provides a method of controlling a vehicle according to the first aspect to sense deposition targets and optionally, to deposit a material thereon and/or therein, the method comprising:
sensing a first deposition target of a set of deposition targets and transmitting a first signal, in response to sensing the first deposition target;
controlling the propulsion system, based, at least in part, on the received first signal; and optionally, depositing at least some of the material on and/or in the first deposition target, based, at least in part, on the received first signal.

The controlling, the vehicle, the material, the sensing, the first deposition target, the set of deposition targets, the transmitting, the propulsion system and/or the depositing maybe described with respect to the first aspect.

The method may include any of the steps described with respect to the first aspect.

In one example, the material comprises a slurry comprising asphalt or cement, as described with respect to the first aspect.

The third aspect provides a method of remediating damage, such as a crack or a pothole, to a thoroughfare, according to the second aspect.

Vehicle

The fourth aspect provides a vehicle, preferably an unmanned and/or autonomous vehicle, for example a robot, the vehicle comprising:
a propulsion system, arranged to propel the vehicle, comprising a set of wheels including a first wheel and/or a set of tracks including a first track;
a deposition apparatus for depositing a foam comprising a polymeric composition; and
a controller arranged to control the deposition apparatus and optionally, the propulsion system;
wherein the deposition apparatus comprises:
a set of reservoirs, including a first reservoir and a second reservoir arranged to receive therein a first component and a second component of the polymeric composition, respectively;
optionally a set of pumps, including a first pump and a second pump arranged to pump the first component and the second component from the first reservoir and the second reservoir, respectively;
a blending chamber in fluid communication with the set of reservoirs via a set of inlet passageways, including a first inlet passageway and a second inlet passageway, wherein the blending chamber is arranged to blend the first component and the second component therein to provide a precursor of the polymeric composition; and
a set of deposition nozzles in fluid communication with the blending chamber via a set of outlet passageways including a first outlet passageway, the set of deposition nozzles including a first deposition nozzle comprising a static mixer arranged to mix the precursor to generate the foam, at least in part, therefrom.

The vehicle of the fourth aspect may be as described with respect to the vehicle of the first aspect and vice versa. That is, the vehicle of the fourth aspect may include any feature of the vehicle of the first aspect and vice versa.

In this way, the vehicle may better overcome obstacles, such as ascending and/or descending steps or stairs and/or crossing chasms (i.e. trenches, gaps and/or crevices), because the vehicle may deposit foam in the path thereof so as to overcome the obstacles. For example, the vehicle may deposit the foam to provide a ramp so as to better ascend and/or descend steps or stairs. For example, the vehicle may deposit the foam to at least partially fill a chasm so as to provide a path thereacross. In this way, ground robots may traverse uneven terrains and overcome obstacles. In this way, disaster relief, search and rescue and/or salvage operations may be facilitated, thereby helping survivors more quickly while better ensuring safety of both first responders and survivors. More generally, the vehicle may be utilised for other applications requiring filling of voids and/or provision of paths, including depositing insulation in buildings, building bridges or pontoons on water, repairing buildings including repairing cracks in roofs, repairing damaged utility pipes and/or military applications. Particularly, the deposition apparatus, as included on the vehicle and as developed by the inventors, has been found to overcome also limitations of conventional deposition apparatuses, allowing improved control of foam properties and improved uniformity of deposition while also having improved robustness to blockages.

As described below in more detail, the blending chamber blends the first component and the second component, thereby at least partially homogenizing the first component and the second component, without generating the foam, thus improving distribution of the first component and the second component to the set of deposition nozzles. Generation of the foam is subsequently from the precursor by mixing thereof using the static mixer in the first deposition nozzle.

Vehicle

The fourth aspect provides the vehicle, preferably an unmanned and/or autonomous vehicle, for example a robot.

In one example, the vehicle is a land craft. In one example, the land craft is a two-wheeled vehicle such as a scooter or a motorbike, a three-wheeled vehicle, a four-wheeled vehicle such as an automobile, a van, a bus, a truck, a forklift truck, a military vehicle, or a vehicle having more than two axles, such as a lorry, a tram or a train. In one example, the land craft is a tracked vehicle, having continuous tracks, such as a recovery or rescue vehicle, a bulldozer, a tractor, a military vehicle such as a tank.

The vehicle is preferably an unmanned and/or autonomous vehicle for example a robot. Generally, an unmanned vehicle (also known as an uncrewed vehicle) is a vehicle without a person on board. An unmanned vehicle can either be a remote controlled vehicle (also known as a remote guided vehicle) or an autonomous vehicle, capable of sensing its environment and navigating autonomously. Unmanned vehicles include unmanned ground vehicles (UGV), such as autonomous cars. For example, autonomous cars (also known as self-driving cars) combine a variety of sensors to perceive their surroundings, such as RADAR, LIDAR, SONAR, GPS, odometry and inertial measurement units, while advanced control systems interpret the sensory information to identify appropriate navigation paths, as well as obstacles.

In one preferred example, the vehicle is a robot, such as a wheeled and/or a tracked robot, particularly a disaster relief robot, a search and rescue robot or a salvage robot. Generally, robots are machines, especially programmable by computers, capable of carrying out complex series of actions automatically. Robots may be controlled by external control devices or control may be embedded (i.e. autonomous robots).

In one example, the vehicle is an existing vehicle and the deposition apparatus is provided therefor, as a retrofit for example.

Propulsion System

The vehicle comprises the propulsion system, arranged to propel the vehicle, comprising a set of wheels including a first wheel and/or a set of tracks including a first track. In one example, the propulsion system comprises a set of legs including a first leg, in addition to or as an alternative to the set of wheels and/or the set of tracks. In one example, the set of wheels includes N wheels, including the first wheel, wherein N is a natural number greater than or equal to 1, for example 1, 2, 3, 4, 5, 6, 7, 8, 9, 10 or more, preferably 2, 4, 6, or 8. In one example, the set of tracks includes M tracks, including the first track, wherein M is a natural number greater than or equal to 1, for example 1, 2, 3, 4, 5, 6, 7, 8, 9, 10 or more, preferably 2, 4, 6, or 8. In one example, the propulsion system comprises a set of actuators, for example motors and/or engines, including a first actuator, arranged to actuate the set of wheels and/or the set of tracks (for example, by being coupled thereto), and hence propel the vehicle. In one example, the propulsion system comprises a power source, for example a battery, and/or a fuel supply.

Deposition Apparatus

The vehicle comprises the deposition apparatus for depositing the foam comprising the polymeric composition, as described below in more detail.

Reservoirs

The deposition apparatus comprises the set of reservoirs, including the first reservoir and the second reservoir arranged to receive therein the first component and the second component of the polymeric composition, respectively. As described below in more detail, foams comprising polymeric compositions may be formed by mixing two or more components. For example, polyurethane foam may be formed by mixing part A and part B (i.e. the first component and the second component of the polymeric composition, respectively). In one example, the first reservoir is arranged to receive therein the first component of the polymeric composition by comprising a plurality of walls forming a container (i.e. a vessel), for example an open or a closeable container, having no perforations therethough for leakage of the first component therefrom. Closeable containers are suitable for pressurised reservoirs, in which the respective components are urged therefrom by pressure, for example due to a pressurised gas. Open containers are suitable for pumped reservoirs, in which the respective components are urged therefrom by pumping, for example by a set up pumps. Preferably, open containers are also closeable so as to contain the respective components therein and/or prevent contamination thereof. The second reservoir may be arranged similarly.

Pumps

The deposition apparatus optionally comprises the set of pumps, including the first pump and the second pump arranged to pump the first component and the second component from the first reservoir and the second reservoir, respectively. In one example, the first pump comprises and/or is a positive displacement pump such as a rotary-type positive displacement pump, a reciprocating-type positive displacement pump or a linear-type positive displacement pump, an impulse pump, a velocity pump, a gravity pump, a steam pump and/or a valveless pump. In one example, the first pump comprises and/or is a syringe. Hence, the first pump and the second pump are arranged to pump the first component and the second component from the first reservoir and the second reservoir, respectively, by positive displacement thereof. In one example, the set of pumps comprises a first pump arranged to pump the first component and the second component from the first reservoir and the second reservoir, respectively, for example by having two inlets and two outlets. Similarly, peristaltic pumps may be configured to separately pump two different fluids in two in two different tubes simultaneously.

In one preferred example, the first pump comprises and/or is a peristaltic pump. A peristaltic pump is a type of positive displacement pump. Fluid to be pumped is contained within a flexible tube fitted inside a circular pump casing (though linear peristaltic pumps have been made). A number of rollers, shoes, or wipers attached to a rotor serially compress (i.e. in turn) the flexible tube. As the rotor turns, the part of the tube under compression closes (or occludes), forcing the fluid through the tube. Additionally, when the tube opens to its natural state after the passing of the cam it draws (restitution) fluid into the pump. This process is called peristalsis and is used in many biological systems such as the gastrointestinal tract. Particularly, since the fluid to be pumped is contained within the flexible tubing, there is no contamination of the pump due to the fluid during pumping.

Blending Chamber

The deposition apparatus comprises the blending chamber in fluid communication with the set of reservoirs via the set of inlet passageways, including the first inlet passageway and the second inlet passageway, wherein the blending chamber is arranged to blend the first component and the second component therein to provide a precursor of the polymeric composition. The deposition apparatus comprises the set of deposition nozzles in fluid communication with the blending chamber via the set of outlet passageways including the first outlet passageway. That is, the blending chamber comprises the set of inlet passageways and the set of outlet passageways.

The blending chamber blends the first component and the second component, thereby at least partially homogenizing the first component and the second component, without generating the foam, thus improving distribution of the first component and the second component to the set of deposition nozzles. By distributing the first component and the second component to each deposition nozzle in a common (i.e. single) passageway, simplicity is improved, since fewer passageways and optionally pumps are required. However, in the absence of such blending, flow of the first component and the second component to the set of deposition nozzles is uneven, such that a ratio of the first component to the second component at the set of deposition nozzles is variable, as a function of time. Without wishing to be bound by any theory, it is thought that the respective viscosities, tackinesses and/or surface tensions of the first component and second component result in generally co-flow thereof, with only a small degree of blending, when introduced into a single passageway, rather than blending. Such variability in the ratio results in turn in variation of the mechanical properties of the foam and/or a curing time thereof. The inventors have determined that by blending the first component and the second component, before distribution to the set of deposition nozzles, such ratio variability is reduced or eliminated, resulting in more consistent mechanical properties of the foam and/or a curing time thereof. This is particularly relevant when the set of outlet passageways includes two or more outlet passageways, such that the blending chamber acts as a manifold. However, over-blending (i.e. mixing) of the first component and the second component results in generation of the foam, which is problematic if occurring in the set of outlet passageways, since blockage thereof results upon curing. Hence, generation of the foam during blending and within the set of outlet passageways is to be avoided, preferably entirely. Without wishing to be bound by any theory, it is thought that generation of the foam is dependent on turbulence of the blending, notwithstanding that foam generation is typically catalysed, as described below. Hence, the blending chamber balances sufficient blending to achieve a more uniform blend of the first component to the second component, so as to reduce variability in the ratio, which attenuating turbulence of the blending, so as to avoid generation of the foam. Particularly, the blending chamber is arranged to blend the first component and the second component therein to provide a precursor of the polymeric composition by having a shape (i.e. an internal shape) that promotes blending while attenuating turbulence therein. In one example, the blending chamber comprises a set of spherical or generally spherical chambers, including a first chamber and/or a second chamber, for example a pair thereof of mutually interconnecting chambers, such as directly interconnecting or indirectly interconnecting via an interconnecting passageway. In one example, the set of inlet passageways are fluidically coupled to the first chamber, for example mutually separated by an angle less than 180°, preferably in a range from 60° to 150° for example 120° such that the first component and the second component flow through the blending chamber together towards the set of outlet passageways. In one example, the set of outlet passageways are fluidically coupled to the second chamber. In one example, the interconnecting passageway has a cross-sectional dimension, for example a diameter, smaller than a diameter of the first chamber and/or the second chamber, for example having an aspect ratio in a range from 1:5 to 5:1. In one example, the blending chamber does not comprise a static mixer, for example a helical static mixer or a plate-type static mixer. In one example, the blending chamber comprises smooth internal walls, without any protuberances therefrom. In other words, the blending chamber is designed to provide low or no turbulent mixing.

Deposition Nozzles

The deposition apparatus comprises the set of deposition nozzles in fluid communication with the blending chamber via the set of outlet passageways including the first outlet passageway, the set of deposition nozzles including a first deposition nozzle comprising the static mixer arranged, for example a helical static mixer or a plate-type static mixer, to mix the precursor to generate the foam, at least in part, therefrom.

Deposition nozzles comprising static mixers are known. Suitable deposition nozzles comprising static mixers are available from Adhesive Dispensing Ltd (UK).

In one example, the set of deposition nozzles includes a second deposition nozzle in fluid communication with the blending chamber via a second outlet passageway of the set of outlet passageways. In this way, the foam may be deposited, for example simultaneously, from a plurality of deposition nozzles. Since the blending chamber is arranged to blend the first component and the second component therein to provide a precursor of the polymeric composition, the same precursor may be distributed to the plurality of deposition nozzles, thereby providing a more uniform blend of the first component to the second component at each deposition nozzle.

In one example, the first deposition nozzle is arranged (for example positioned) forwardly of the set of wheels, preferably forwardly of the first wheel, and/or forwardly of the set of tracks, preferably forwardly of the first track. In this way, the foam may be deposited in front of, for example only in front of, the set of wheels and/or the set of tracks to provide a ramp or a path, for example using a reduced and/or a minimised amount of foam. In one example, the first deposition nozzle is arranged rearwardly of the set of wheels, preferably rearwardly of the first wheel, and/or rearwardly of the set of tracks, preferably rearwardly of the first track.

In one example, the first deposition nozzle is arranged (for example positioned) aligned with the set of wheels, preferably aligned with the first wheel, and/or aligned with the set of tracks, preferably aligned with the first track. In this way, the foam may be deposited directly in line with, for example only directly in line with, the set of wheels and/or the set of tracks to provide a ramp or a path, for example using a reduced and/or a minimised amount of foam.

Material

In one example, surfaces wetted by the first component, the second component, the precursor and/or the polymeric composition are formed from and/or coated with polytetrafluoroethylene (PTFE). In this way, build-up of residue thereof thereupon is reduced. In one example, the set of inlet passageways, the blending chamber, the set of outlet passageways and/or the set of deposition nozzles are formed from and/or coated (i.e. internal surfaces thereof) with PTFE.

Sensors

In one example, the vehicle comprises a set of sensors including a first sensor arranged (for example positioned) to sense an obstacle and to transmit a first signal to the controller, in response to sensing the obstacle. In one example, the first sensor comprises and/or is a proximity sensor, for example an inductive sensor, a capacitive sensor, a photoelectric sensor, an ultrasonic sensor, a retroreflective sensor or a diffuse sensor. In one example, the first sensor comprises an array of such sensors. Generally, proximity sensors detect the presence or absence of objects, such as obstacles, using electromagnetic fields light, and/or sound. In one example, the set of sensors includes S sensors, for example positioned as an array, wherein S is a natural number greater than or equal to 1 for example 1, 2, 3, 4, 5, 6, 7, 8, 9, 10 or more. In one example, the set of sensors is arranged (for example positioned) to sense an obstacle in a path of the vehicle, for example in front of, behind, below and/or above. Ultrasonic sensors are preferred. Suitable ultrasonic sensors are available from Acme Systems srl (Italy), such as the HC-SR04 ultrasonic sensor, having a sensed range from 2 cm to 400 cm,

Solvent

In one example, the set of reservoirs includes a third reservoir arranged to receive therein a solvent for cleaning the blending chamber, the set of outlet passageways and/or the set of deposition nozzles; optionally the set of pumps includes a third pump arranged to pump the solvent from the third reservoir; and the set of inlet passageways includes a third inlet passageway. In this way, the blending chamber, the set of outlet passageways and/or the set of deposition nozzles may be cleaned, for example periodically, so as to reduce build up of the first component, the second component, the precursor and/or the foam respectively therein. The solvent may be selected according to the first component, the second component, the precursor and/or the foam. For example, isopropyl alcohol is a suitable solvent for PU and the first and second components thereof. The third reservoir and/or the third pump may be as described with respect to the first reservoir and the first pump, respectively.

In one example, the deposition apparatus comprises a solvent recovery apparatus, optionally comprising a filter, for recovering and optionally filtering the solvent. In one example, the deposition apparatus comprises a solvent recovery pump for pumping the recovered and optionally filtered solvent to the third reservoir. In this way, solvent consumption is reduced while environmental contamination is avoided.

Controller

The vehicle comprises the controller arranged to control the deposition apparatus and, optionally, the propulsion system. In one example, the controller comprises a processor and a memory and is arranged to control the deposition apparatus and optionally, the propulsion system, using software (i.e. programmatic instructions executed by the processor). In one example, the vehicle comprises a communications (wired and/or wireless) interface for onboard communication and/or communication with external devices.

In one example, the controller is arranged to receive, for example via the communications interface, the first signal transmitted by the first sensor and to control the propulsion system and/or the deposition apparatus, based, at least in part, on the received first signal. In this way, the controller may control the propulsion system and/or the deposition apparatus responsive to sensing of an obstacle, for example to slow, stop or change direction of propulsion and/or to start or stop deposition of foam.

In one example, the controller is arranged to control the propulsion system to control a speed and/or heading (i.e. direction, bearing, orientation) of the vehicle.

In one example, the controller is arranged to control the propulsion system to move the vehicle rearwardly or forwardly and to control the deposition apparatus to deposit the foam, based, at least in part, on the received first signal. For example, upon sensing of an obstacle, the controller may control the propulsion system to slow, stop and/or reverse the vehicle and to deposit the foam to provide a ramp or a path.

In one example, the controller is arranged to control the propulsion system to move the vehicle rearwardly and to control the deposition apparatus to deposit the foam, based, at least in part, on the received first signal, while the vehicle moves rearwardly. In this way, the controller may control the deposition apparatus to deposit the foam to provide a ramp, tapering away from the obstacle, such as a step.

In one example, the controller is arranged to control the deposition apparatus to deposit the foam, based, at least in part, on a distance from an obstacle, for example as determined from the received first signal. In one example, the controller is arranged to control a rate of deposition of the foam by the deposition apparatus, based, at least in part, on a distance from an obstacle, for example as determined from the received first signal. In this way, a ramp may be provided, tapering away from the obstacle, such as a step.

In one example, the controller is arranged to control the propulsion system to move the vehicle forwardly after depositing the foam. In this way, the vehicle may overcome the obstacle, for example a step, by moving up a ramp provided by the deposited foam.

In one example, the controller is arranged to control the propulsion system and/or the deposition apparatus to repeatedly move the vehicle and/or deposit the foam. In this way, the vehicle may overcome a relatively larger obstacle.

In one example, the controller is arranged to control the propulsion system to move the vehicle forwardly and to control the deposition apparatus to deposit the foam, based, at least in part, on the received first signal, optionally while the vehicle moves forwardly. In this way, a chasm may be at least partially filled, for example.

In one example, the controller is arranged to control a speed of the set of pumps, for example respective speeds of the first pump and the second pump, for example as a function of time. In this way, a rate of deposition of the polymeric composition may be controlled, for example to provide a ramp. In one example, the controller is arranged to control a speed of the set of pumps, for example respective speeds of the first pump and the second pump independently. In this way, a ratio of the first component to the second component may be controlled, thereby controlling a mechanical property and/or a curing time of the deposited polymeric composition. In one example, the controller is arranged to control a deposition pattern of the polymeric composition deposited by the deposition apparatus, such as to fill a cavity and/or define a ramp, for example by controlling the deposition apparatus and optionally, the propulsion system, for example synchronously (i.e. in a coordinated manner). In one example, the deposition pattern comprises one or more lines of deposited polymeric composition. In one example, the deposition pattern comprises one or more points of deposited polymeric composition, for example defining a matrix of deposited polymeric composition. In one example, the deposition pattern comprises one or more layers of deposited polymeric composition.

In one example, the controller is arranged to calculate a distance from the object, based, at least in part, on the first signal. In one example, the controller is arranged to calculate a depth and/or a volume of a void, such as a chasm, based, at least in part, on the first signal. In one example, the controller is arranged to calculate an amount of the first component and/or the first component to be deposited as the polymeric composition based, at least in part, on the first signal, for example by using the volume of the void to be filled and an expected expansion of the foam.

Machining

In one example, the deposition apparatus comprises a machine tool, for example a mill, a drill or a cutter, arranged to machine, for example mill, drill and/or cut, the foam. In this way, a surface of the foam may be machined, such as to facilitate further deposition of foam thereabove and/or to provide a required shape of the foam. In one example, the controller is arranged to control the machine tool.

Foam

The foam (also known as a polymeric foam) comprises the polymeric composition. Generally, polymeric foams are foams, in liquid or solidified form, formed from polymers. In one example, the foam comprises and/or is ethylene-vinyl acetate (EVA) foam (copolymers of ethylene and vinyl acetate, also known aspolyethylene-vinyl acetate (PEVA)), low-density polyethylene (LDPE) foam (first grade of polyethylene (PE)), nitrile rubber (NBR) foam (copolymers of acrylonitrile (ACN) and butadiene), polychloroprene foam (also known as neoprene), polyimide foam, polypropylene (PP) foam (including expanded polypropylene (EPP) and polypropylene paper (PPP)), polystyrene (PS) foam (including expanded polystyrene (EPS), extruded polystyrene foam (XPS) and polystyrene paper (PSP)), styrofoam (including extruded polystyrene foam (XPS) and sometimes expanded polystyrene (EPS)), polyurethane (PU) foam (including LRPu low-resilience polyurethane, memory foam and sorbothane), polyethylene foam, polyvinyl chloride (PVC) foam (including closed-cell PVC foamboard), silicone foam and/or microcellular foam. In one preferred example, the foam comprises and/or is polyurethane foam.

Polyurethane (also known as PUR and PU) is a polymer composed of organic units joined by carbamate (urethane) links. While most polyurethanes are thermosetting polymers, thermoplastic polyurethanes are also available.

Polyurethane polymers are typically formed by reacting a di- or tri poly-isocyanate with a polyol (i.e. the first component and the second component of the polymeric composition, respectively). Since polyurethanes contain two types of monomers, which polymerise one after the other, they are classed as alternating copolymers. Both the isocyanates and polyols used to make polyurethanes contain, on average, two or more functional groups per molecule.

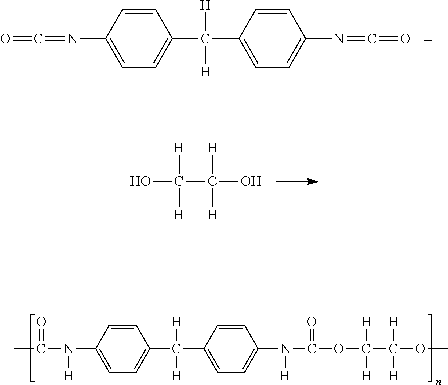

Polyurethane synthesis, wherein the urethane groups —NH—(C═O)—O— link the molecular units. In more detail, polyurethanes are in the class of compounds called reaction polymers, which include epoxies, unsaturated polyesters, and phenolics. Polyurethanes are produced by reacting an isocyanate containing two or more isocyanate groups per molecule (R—(N═C=O)ₙ) with a polyol containing on average two or more hydroxyl groups per molecule (R′—(OH)n[17]) in the presence of a catalyst or by activation with ultraviolet light.

The properties of a polyurethane are greatly influenced by the types of isocyanates and polyols used to make it. Long, flexible segments, contributed by the polyol, give soft, elastic polymer. High amounts of crosslinking give tough or rigid polymers. Long chains and low crosslinking give a polymer that is very stretchy, short chains with lots of crosslinks produce a hard polymer while long chains and intermediate crosslinking give a polymer useful for making foam. The crosslinking present in polyurethanes means that the polymer consists of a three-dimensional network and molecular weight is very high. In some respects a piece of polyurethane can be regarded as one giant molecule. One consequence of this is that typical polyurethanes do not soften or melt when they are heated; they are thermosetting polymers. The choices available for the isocyanates and polyols, in addition to other additives and processing conditions allow polyurethanes to have the very wide range of properties that make them such widely used polymers.

Isocyanates are very reactive materials. This makes them useful in making polymers but also requires special care in handling and use. The aromatic isocyanates, diphenylmethane diisocyanate (MDI) or toluene diisocyanate (TDI) are more reactive than aliphatic isocyanates, such as hexamethylene diisocyanate (HDI) or isophorone diisocyanate (IPDI). Most of the isocyanates are difunctional, that is they have exactly two isocyanate groups per molecule. An important exception to this is polymeric diphenylmethane diisocyanate, which is a mixture of molecules with two, three, and four or more isocyanate groups. In cases like this the material has an average functionality greater than two, commonly 2.7.

Polyols are polymers in their own right and have on average two or more hydroxyl groups per molecule. Polyether polyols are mostly made by co-polymerizing ethylene oxide and propylene oxide with a suitable polyol precursor. Polyester polyols are made similarly to polyester polymers. The polyols used to make polyurethanes are not “pure” compounds since they are often mixtures of similar molecules with different molecular weights and mixtures of molecules that contain different numbers of hydroxyl groups, which is why the “average functionality” is often mentioned. Despite them being complex mixtures, industrial grade polyols have their composition sufficiently well controlled to produce polyurethanes having consistent properties. As mentioned earlier, it is the length of the polyol chain and the functionality that contribute much to the properties of the final polymer. Polyols used to make rigid polyurethanes have molecular weights in the hundreds, while those used to make flexible polyurethanes have molecular weights up to ten thousand or more.

The polymerization reaction makes a polymer containing the urethane linkage, —RNHCOOR′— and is catalyzed by tertiary amines, such as 1,4-diazabicyclo[2.2.2]octane (also called DABCO), and metallic compounds, such as dibutyltin dilaurate or bismuth octanoate. Alternatively, it can be promoted by ultraviolet light. This is often referred to as the gellation reaction or simply gelling.

If water is present in the reaction mixture (it is often added intentionally to make foams), the isocyanate reacts with water to form a urea linkage and carbon dioxide gas and the resulting polymer contains both urethane and urea linkages. This reaction is referred to as the blowing reaction and is catalyzed by tertiary amines like bis-(2-dimethylaminoethyl)ether.

A third reaction, particularly important in making insulating rigid foams is the isocyanate trimerization reaction, which is catalyzed by potassium octoate, for example.

One of the most desirable attributes of polyurethanes is their ability to be turned into foam. Making a foam requires the formation of a gas at the same time as the urethane polymerization (gellation) is occurring. The gas can be carbon dioxide, either generated by reacting isocyanate with water or added as a gas; it can also be produced by boiling volatile liquids. In the latter case heat generated by the polymerization causes the liquids to vaporize. The liquids can be HFC-245fa (1,1,1,3,3-pentafluoropropane) and HFC-134a (1,1,1,2-tetrafluoroethane), and hydrocarbons such as n-pentane.

The balance between gellation and blowing is sensitive to operating parameters including the concentrations of water and catalyst. The reaction to generate carbon dioxide involves water reacting with an isocyanate first forming an unstable carbamic acid, which then decomposes into carbon dioxide and an amine. The amine reacts with more isocyanate to give a substituted urea. Water has a very low molecular weight, so even though the weight percent of water may be small, the molar proportion of water may be high and considerable amounts of urea produced. The urea is not very soluble in the reaction mixture and tends to form separate “hard segment” phases consisting mostly of polyurea. The concentration and organization of these polyurea phases can have a significant impact on the properties of the polyurethane foam.

High-density microcellular foams can be formed without the addition of blowing agents by mechanically frothing or nucleating the polyol component prior to use.

Surfactants are used in polyurethane foams to emulsify the liquid components, regulate cell size, and stabilize the cell structure to prevent collapse and surface defects. Rigid foam surfactants are designed to produce very fine cells and a very high closed cell content. Flexible foam surfactants are designed to stabilize the reaction mass while at the same time maximizing open cell content to prevent the foam from shrinking.

An even more rigid foam can be made with the use of specialty trimerization catalysts which create cyclic structures within the foam matrix, giving a harder, more thermally stable structure, designated as polyisocyanurate foams. Such properties are desired in rigid foam products used in the construction sector.

Foams can be either “closed-cell”, where most of the original bubbles or cells remain intact, or “open-cell”, where the bubbles have broken but the edges of the bubbles are stiff enough to retain their shape. Open-cell foams feel soft and allow air to flow through, so they are comfortable when used in seat cushions or mattresses. Closed-cell rigid foams are used as thermal insulation, for example in refrigerators.

Polyurethanes are conventionally produced by mixing two or more liquid streams (i.e. the first component and the second component of the polymeric composition, respectively). The polyol stream contains catalysts, surfactants, blowing agents and so on. The two components are referred to as a polyurethane system, or simply a system. The isocyanate is commonly referred to in North America as the ‘A-side’ or just the ‘iso’. The blend of polyols and other additives is commonly referred to as the ‘B-side’ or as the ‘poly’. This mixture might also be called a ‘resin’ or ‘resin blend’. In Europe, the meanings for ‘A-side’ and ‘B-side’ are reversed. Resin blend additives may include chain extenders, cross linkers, surfactants, flame retardants, blowing agents, pigments, and fillers. Polyurethane can be made in a variety of densities and hardnesses by varying the isocyanate, polyol or additives.

The first component and the second component of the polymeric composition are blended, using the blending chamber, to provide the precursor of the polymeric composition. The foam is generated, at least in part, by mixing, using the static mixer included in the first deposition nozzle, the precursor.

### Preferred Example

In one example, the vehicle, preferably an unmanned and/or autonomous vehicle, for example a robot, comprises:
a propulsion system, arranged to propel the vehicle, comprising a set of wheels including a first wheel and/or a set of tracks including a first track;
a set of sensors, including a first sensor, arranged to sense a first deposition target of a set of deposition targets in the surface and to transmit a first signal, in response to sensing the first deposition target;
a first deposition apparatus for depositing a material on and/or in the first deposition target;
a second deposition apparatus for depositing a foam comprising a polymeric composition; and
a controller arranged to receive the first signal transmitted by the first sensor and to control the propulsion system and/or the first deposition apparatus, based, at least in part, on the received first signal, to control the second deposition apparatus and optionally, the propulsion system;
wherein the second deposition apparatus comprises:
a set of reservoirs, including a first reservoir and a second reservoir arranged to receive therein a first component and a second component of the polymeric composition, respectively; optionally a set of pumps, including a first pump and a second pump arranged to pump the first component and the second component from the first reservoir and the second reservoir, respectively;
a blending chamber in fluid communication with the set of reservoirs via a set of inlet passageways, including a first inlet passageway and a second inlet passageway, wherein the blending chamber is arranged to blend the first component and the second component therein to provide a precursor of the polymeric composition; and
a set of deposition nozzles in fluid communication with the blending chamber via a set of outlet passageways including a first outlet passageway, the set of deposition nozzles including a first deposition nozzle comprising a static mixer arranged to mix the precursor to generate the foam, at least in part, therefrom.

That is, this example combines the vehicle according to the first aspect and the vehicle according to the fourth aspect, as described previously.

Method of Controlling a Vehicle

The fifth aspect provides a method of controlling a vehicle according to the fourth aspect to deposit a foam comprising a polymeric composition, the method comprising:
blending, using the blending chamber, the first component and the second component of the polymeric composition to provide the precursor of the polymeric composition;
generating the foam, at least in part, by mixing, using the static mixer included in the first deposition nozzle, the precursor; and
depositing the foam, at least in part, via the first deposition nozzle.

The vehicle, the foam, the polymeric composition, the blending chamber, the first component of the polymeric composition, the second component of the polymeric composition, the precursor of the polymeric composition, the foam, the static mixer and/or the first deposition nozzle may be as described with respect to the fourth aspect.

The method according to the fifth aspect may include any step as described with respect to the method according to the second aspect and/or the third aspect and vice versa.

In one example, the method comprises depositing the foam, at least in part, via the first deposition nozzle on and/or in the first deposition target, based, at least in part, on the received first signal.

In one example, the method comprises depositing at least some of the material on and/or in the deposited foam and/or in the first deposition target, based, at least in part, on the received first signal, for example firstly depositing the foam and subsequently, after curing thereof, depositing the material on the cured foam.

In one example, the method comprises receiving a first signal transmitted by a first sensor and to controlling the propulsion system and/or the deposition apparatus, based, at least in part, on the received first signal.

In one example, the method comprises moving the vehicle rearwardly or forwardly and depositing the foam, based, at least in part, on the received first signal.

In one example, the method comprises moving the vehicle rearwardly and depositing the foam, based, at least in part, on the received first signal, while the vehicle moves rearwardly. In one example, the method comprises depositing the foam, based, at least in part, on a distance from an obstacle, for example as determined from the received first signal. In one example, the method comprises controlling a rate of deposition of the foam, based, at least in part, on a distance from an obstacle, for example as determined from the received first signal. In one example, the method comprises moving the vehicle forwardly after depositing the foam. In one example, the method comprises repeatedly moving the vehicle and/or depositing the foam.

In one example, the method comprises moving the vehicle forwardly and depositing the foam, based, at least in part, on the received first signal, optionally while the vehicle moves forwardly.

In one example, the method comprises blending, using the blending chamber, the first component and the second component of the polymeric composition to provide the precursor of the polymeric composition without generating, at least in part, the foam.

In one example, the method comprises generating the foam, at least in part, only by mixing, using the static mixer included in the first deposition nozzle, the precursor.

In one example, the method comprises pumping the first component and the second component of the polymeric composition into the blending chamber.

In one example, the method comprises dividing the precursor, for example equally, by the blending chamber, between a set of deposition nozzles including the first deposition nozzle and a second deposition nozzle.

Deposition Apparatus

The sixth aspect provides a deposition apparatus for depositing a foam comprising a polymeric composition, the deposition apparatus comprising:
a set of reservoirs, including a first reservoir and a second reservoir arranged to receive therein a first component and a second component of the polymeric composition, respectively;
optionally a set of pumps, including a first pump and a second pump arranged to pump the first component and the second component from the first reservoir and the second reservoir, respectively;
a blending chamber in fluid communication with the set of reservoirs via a set of inlet passageways, including a first inlet passageway and a second inlet passageway, wherein the blending chamber is arranged to blend the first component and the second component therein to provide a precursor of the polymeric composition; and
a set of deposition nozzles in fluid communication with the blending chamber via a set of outlet passageways including a first outlet passageway, the set of deposition nozzles including a first deposition nozzle comprising a static mixer arranged to mix the precursor to generate the foam, at least in part, therefrom.

In this way, the deposition apparatus may be utilised for other applications, including depositing insulation in buildings, building bridges or pontoons on water, repairing buildings and/or damaged utility pipes and/or military applications.

The deposition apparatus, the foam the polymeric composition, the set of reservoirs, the first reservoir, the second reservoir, the first component of the polymeric composition, the second component of the polymeric composition, the set of pumps, the first pump, the second pump, the blending chamber, the set of inlet passageways, the first inlet passageway, the second inlet passageway, the precursor of the polymeric composition, the set of deposition nozzles, the set of outlet passageways, the first outlet passageway, the first deposition nozzle and/or the static mixer may be as described with respect to the fourth aspect.

Method of Depositing a Foam

The seventh aspect provides a method of depositing a foam comprising a polymeric composition, the method comprising:
blending, using a blending chamber, a first component and a second component of the polymeric composition to provide a precursor of the polymeric composition;
generating the foam, at least in part, by mixing, using a static mixer included in a first deposition nozzle, the precursor; and
depositing the foam, at least in part, via the first deposition nozzle.

The foam, the polymeric composition, the blending, the blending chamber, the first component of the polymeric composition, the second component of the polymeric composition, the precursor of the polymeric composition, the generating, the foam, the mixing, the static mixer, the first deposition nozzle and/or the depositing the foam may be as described with respect to the fourth aspect and/or the fifth aspect.

Use

The eighth aspect provides use of a blending chamber to blend a first component and a second component of a polymeric composition to provide a precursor of the polymeric composition prior to generating a foam, at least in part, from the precursor using a static mixer. The blending chamber, the first component, the second component, the polymeric composition, the precursor of the polymeric composition, the foam, and/or the static mixer may be as described with respect to the fourth aspect.

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like. The term “consisting of” or “consists of” means including the components specified but excluding other components. Whenever appropriate, depending upon the context, the use of the term “comprises” or “comprising” may also be taken to include the meaning “consists essentially of” or “consisting essentially of”, and also may also be taken to include the meaning “consists of” or “consisting of”. The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1 schematically depicts a vehicle according to an exemplary embodiment;

FIG. 2 schematically depicts a method according to an exemplary embodiment;

FIGS. 3A (front perspective view) and 3B (plan view) are photographs of a propulsion system of a vehicle according to an exemplary embodiment; FIGS. 3C (plan view) and 3D (front perspective view) are photographs of a set of sensors of the vehicle; and FIGS. 3E (rear perspective view) and 3F (front perspective view) are photographs of a deposition apparatus of the vehicle;

FIG. 4A is a block diagram of a visual servoing control system of the vehicle of FIGS. 3A to 3F; and FIG. 4B is a flow diagram of the Raspberry Pi processing loop;

FIG. 5 shows stages of image processing: A image capture; B median blurring; C thresholding; D erosion; E contour detection; and F error detection;

FIG. 6 shows photographs of a deposition apparatus detection and actuation accuracy test;

FIG. 7 shows results of the deposition apparatus detection and actuation accuracy test of FIG. 5; A original image; B green line detected; and C red line detected;

FIG. 8 shows photographs of the cement deposition apparatus and visual-servoing system, attempting to create prints along a simulated pre-disposition: A to C show under-extrusion from the depositor leading to either; D to E show over-extrusion; and F shows quasi-successful and consistent deposition;

FIG. 9 shows a photograph of successful and consistent deposition;

FIG. 10 shows photographs of a five layer dynamic print experiment, showing: A initial layer deposited using the visual servoing of the floor pattern; B second layer deposited using the visual servoing of the pre-deposited layer; C third layer deposited in the same style; and D final layer of deposit;

FIG. 11 shows photographs of the five layer dynamic print experiment of FIG. 10, showing: A side profile of the first two layers; B side profile of the first three layers; C side profile of the five layers; and D top profile of the full print;

FIG. 12 shows photographs of a multi-layer straight line deposit test: A the vehicle detects a crack in the ground; and fills it with 4 layers of cement (B to D);

FIG. 13 shows photographs of a single-layer dynamic line deposit test: A the vehicle detects a non-straight crack in the ground; and tracks the crack while filling it with a single layer of cement (B to D);

FIG. 14 shows as photograph of the components of an Archimedes screw-style deposition apparatus for the vehicle of FIGS. 3A to 3F;

FIG. 15 shows photographs of concrete deposited at the three different pumping speeds using the deposition apparatus of FIG. 14.

FIG. 16 schematically depicts a vehicle according to an exemplary embodiment;

FIG. 17 schematically depicts a method of depositing a foam according to an exemplary embodiment;

FIG. 18 shows stress-strain curves of polyurethane foams;

FIGS. 19A (front perspective view) and 19B (plan view) are photographs of a part of a vehicle according to an exemplary embodiment;

FIG. 20A schematically depicts a method of controlling the vehicle of FIGS. 19A and 19B according to an exemplary embodiment and FIG. 20B schematically depicts the vehicle, in use, controlled according to the method of FIG. 20A;

FIG. 21A schematically depicts a method of controlling the vehicle of FIGS. 19A and 19B according to an exemplary embodiment and FIG. 21B schematically depicts the vehicle, in use, controlled according to the method of FIG. 21A;

FIGS. 22A (plan view) and 22B (front perspective view) are photographs of the vehicle of FIGS. 19A and 19B, in more detail;

FIG. 23 is a time series of photographs (side elevation view) of the vehicle of FIGS. 19A and 19B, in use;

FIG. 24A is a time series of photographs (side elevation view) of the vehicle of FIGS. 19A and 19B, in use, and FIG. 24A is a time series of photographs (plan view) of the vehicle of FIGS. 19A and 19B, in use;

FIG. 25 is a time series of photographs (side elevation view) of the vehicle of FIGS. 19A and 19B, in use;

FIG. 26A is a CAD perspective view and FIG. 26B is a schematic cross-sectional view of a blending chamber of the deposition apparatus of the vehicle of FIGS. 19A and 19B;

FIG. 27 is a photograph (perspective view) of a deposition nozzle of the deposition apparatus of the vehicle of FIGS. 19A and 19B;

FIG. 28 schematically depicts a method of controlling a vehicle to deposit a foam comprising a polymeric composition according to an exemplary embodiment;

FIG. 29 schematically depicts a method of depositing a foam comprising a polymeric composition according to an exemplary embodiment;

FIG. 30 is a photograph of the combined vehicle including foam deposition system 1, cement deposition module 2 and base tracked mobile vehicle 3;

FIG. 31 is a time series of photographs of the square path follow demonstration highlighting the following: 1) travel to waypoint; 2) re-orientate to next waypoint; 3) begin extruding; 4) stop extruding; 5) follow path; 6) continue path; 7) continue path; 8) continue path; 9) detect previously deposited layer, position outlet and extrude; 10) detect no previous deposit, to stop extrusion; 11) follow same previous path; and 12) detect previously deposited layer, position outlet and extrude.

FIG. 32 includes photographs of deposition created by the straight line integration demonstration; and

FIG. 33 is a time series of photographs of the system: 1) detecting cementitious deposit and depositing PUF; 2) detecting an end to the previous deposit; 3) climbing on the 1st tier; and 4) climbing on the 2nd tier ramp.

### DETAILED DESCRIPTION OF THE DRAWINGS

Vehicle

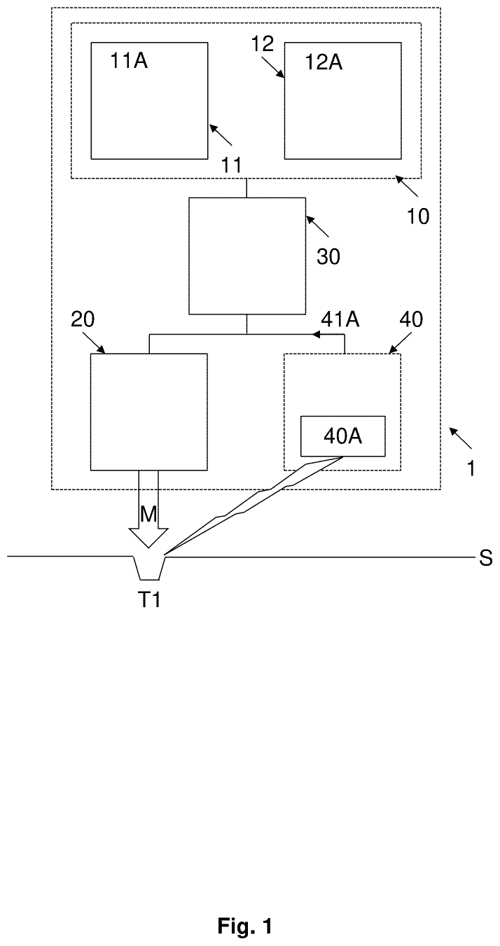

FIG. 1 schematically depicts a vehicle 1 according to an exemplary embodiment. The vehicle 1 is preferably an unmanned and/or autonomous vehicle, for example a robot. The vehicle 1 comprises: a propulsion system 10, arranged to propel the vehicle 1 on a surface S, comprising a set of wheels 11 including a first wheel 11A and/or a set of tracks 12 including a first track 12A; a set of sensors 40, including a first sensor 40A, arranged to sense a first deposition target T1 of a set of deposition targets T in the surface S and to transmit a first signal 41A, in response to sensing the first deposition target T1; optionally, a deposition apparatus 20 for depositing a material M on and/or in the first deposition target T; and a controller 30 arranged to receive the first signal 41A transmitted by the first sensor 40A and to control the propulsion system 10 and/or the deposition apparatus 20, based, at least in part, on the received first signal 41A.

Method

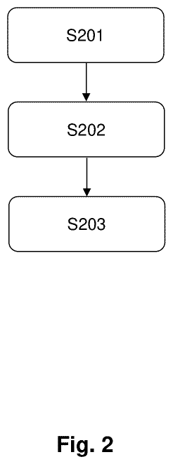

FIG. 2 schematically depicts a method according to an exemplary embodiment. The method is of controlling a vehicle, for example the vehicle 1, to sense deposition targets and optionally, to deposit a material thereon and/or therein.

At S201, the method comprises sensing a first deposition target of a set of deposition targets and transmitting a first signal, in response to sensing the first deposition target.

At S202, the method comprises controlling the propulsion system, based, at least in part, on the received first signal.

At S203, the method comprises optionally, depositing at least some of the material on and/or in the first deposition target, based, at least in part, on the received first signal.

Example Vehicle

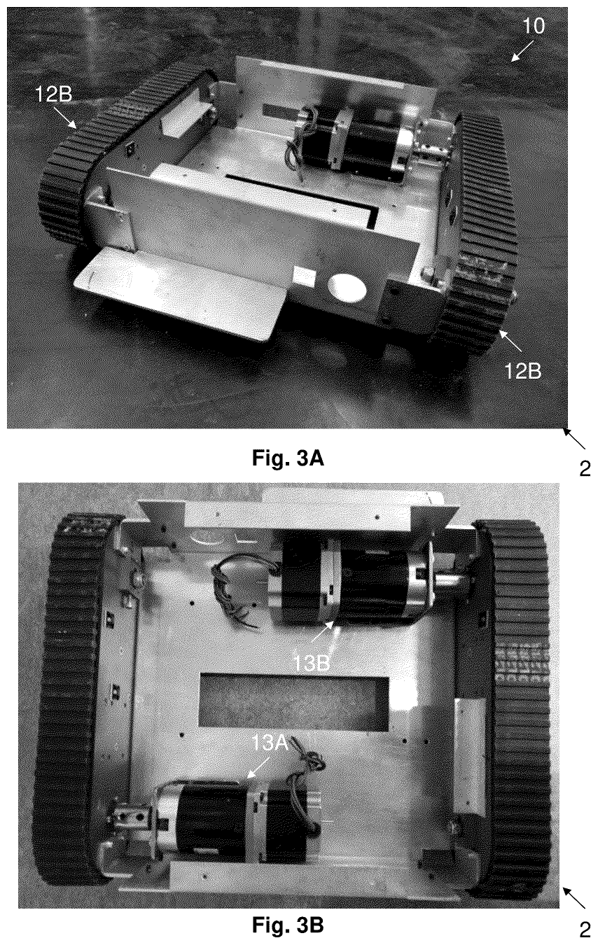

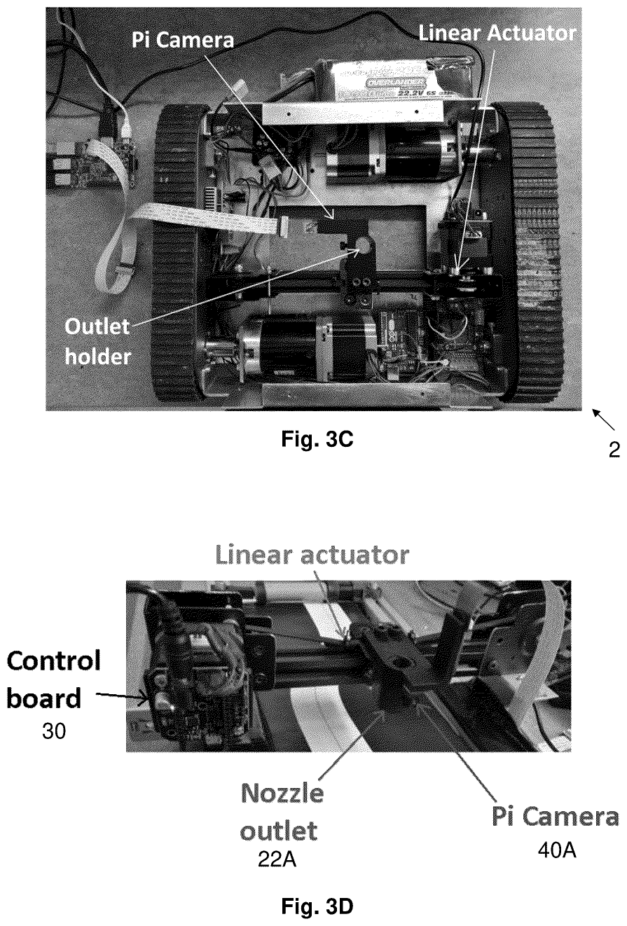

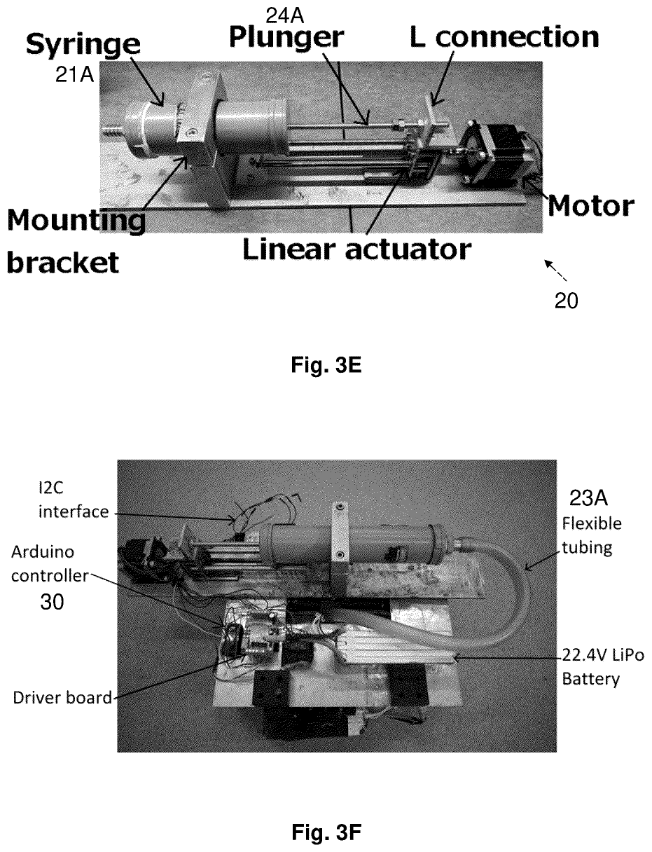

FIGS. 3A (front perspective view) and 3B (plan view) are photographs of a propulsion system of a vehicle 2 according to an exemplary embodiment; FIGS. 3C (plan view) and 3D (front perspective view) are photographs of a set of sensors 40 of the vehicle; and FIGS. 3E (rear perspective view) and 3F (front perspective view) are photographs of a deposition apparatus of the vehicle 2.

In this example, the vehicle 2 is an autonomous ground tracked vehicle 2, referred to also as a rover or platform herein. The vehicle 2 is generally as described with respect to the vehicle 1, repetition of which is avoided, for brevity. Like reference signs denote like features.

The vehicle 2 comprises the propulsion system 10, arranged to propel the vehicle 2 on the surface, the set of tracks 12 including the first track 12A and a second track 12B. In this example, the propulsion system 10 comprises a set of actuators 13, including a first actuator 13A and a second actuator 13B, arranged to actuate the set of tracks 12, particularly the first track 12A and the second track 12B respectively. In this example, the first actuator 13A and the second actuator 13B are motors, as described below. In this example, the propulsion system 10 comprises a battery.

This vehicle 2 is a two-tracked vehicle with a track height of 100 mm and a track length of 300 mm. The propulsion system 10 is driven by two large stepper motors (RB-Phi-266, Robotshop), which would allow a 50 kg payload to be pulled along an even medium friction surface. The vehicle 2 is controlled by a central Arduino Mega 2560 board (i.e. the controller 30) which controls the motor speeds via two Arduino Nano boards and the pumping systems via another Arduino Mega 2560. A digital compass is connected to the central control board to feed orientation information back to the controller and positional information is calculated from the localisation system, as described below.

In this example, the first sensor 40A is an optical sensor, particularly an imager. In this example, the imager is a 2D or a 3D imager, particularly a 2D camera being a Raspberry Pi camera. In this example, the vehicle 1 comprises a linear actuator 50, arranged to move the first sensor 40A transverse to the vehicle 1. In this example, the first signal 41A comprises an image of the first deposition target T1. In this example, the set of sensors 40 is arranged to sense the first deposition target T1 after depositing the material M therein and/or thereon. The vehicle 2 comprises the controller 30 arranged to receive the first signal transmitted by the first sensor 40A and to control the propulsion system 10 and/or the deposition apparatus, based, at least in part, on the received first signal. In this example, the controller 30 is arranged to control the propulsion system 10 to move the vehicle 2 and to control the deposition apparatus to deposit at least some of the material on and/or in the first deposition target T1, based, at least in part, on the received first signal, optionally while the vehicle 2 is moving. In this example, the controller 30 is arranged to control the propulsion system 10 to follow the first deposition target T1, based, at least in part, on the received first signal. In this example, the controller 30 is arranged to control the deposition apparatus to deposit at least some of the material on and/or in the first deposition target T1, based, at least in part, on the received first signal, while the vehicle 2 is following the first deposition target T1. In this example, the controller 30 is arranged to control the deposition apparatus to repeatedly deposit at least some of the material on and/or in the first deposition target T1, based, at least in part, on the received first signal. In this example, the controller 30 is arranged to determine a first dimension of the first deposition target T1, based, at least in part, on the received first signal. In this example, the controller 30 is arranged to control the deposition apparatus to deposit at least some of the material on and/or in the first deposition target T1, based, at least in part, on the determined first dimension. The vehicle 2 comprises the deposition apparatus for depositing the material on and/or in the first deposition target T1. In this example, the deposition apparatus 20 comprises: a set of reservoirs 21, including a first reservoir 21A, arranged to receive the material M therein; and a set of deposition nozzles 22, including a first deposition nozzle 22A, in fluid communication with the set of reservoirs 21 via a set of outlet passageways 23 including a first outlet passageway 23A; a set of extruders 24, including a first extruder 24A, arranged to urge at least some of the material M received in the set of reservoirs 21 through the set of deposition nozzles 22. In this example, the first extruder 21A is a syringe extruder, arranged to urge a cementitious material from the first reservoir 21A, having a volume of 330 ml, via the first outlet passageway 23A, having a taper angle of 24° from an internal diameter of 56 mm to an internal diameter of 10 mm, corresponding with an internal diameter of 10 mm of the first deposition nozzle 22A. In this example, the first deposition nozzle 22A is arranged rearwardly of the first sensor 40A. In this example, the vehicle 2 comprises the linear actuator 50, arranged to move the first deposition nozzle 22A transverse to the vehicle 2. Particularly, in this example, the first sensor 40A and the first deposition nozzle 22A are mounted on the linear actuator 50 and move together, transverse the vehicle 2. In this example, the vehicle 2 comprises a closed-loop actuation system to position the first deposition nozzle 22A relative to the first deposition target T1. In this way, sub-cm deposition accuracy may be achieved. In more detail, the localisation of the vehicle 2 had a mean localisation error of 1.57 cm and an average standard deviation of 1.39 cm throughout a test arena. Despite this accuracy, positioning and therefore deposition errors, could occur and accumulate over several layers. The alignment of subsequent layers, following deposition of the base layer, may require sub-cm deposition accuracy. The main task of the closed-loop actuation system was to control outlet positioning to align with predeposited material layers. The system is a visual-servoing system, which uses real-time information from a vision sensor (i.e. the first sensor 40A) to control the position of the first deposition nozzle 22A, using the linear actuator 50.

Briefly, visual-servoing may be summarised into three stages:
1. Digitalise and refine images;
2. Identify previously deposited layer;
3. Ensure deposition nozzle convergence to identified previously deposited layer.

The process involves the error computation directly on the values associated with the relevant features, extracted from a 2D image (i.e. the first signal 41A). The robot 2 then actuates to ensure that the current image meets the desired values, e.g. the linear actuator 50 moves to ensure the first deposition nozzle 22A is positioned above the previously deposited layers. One further consideration is the positioning of the camera relative to the end actuator. Two architectures are possible: Eye-In-Hand, where the camera is rigidly mounted to the robot's end actuator, and Eye-to-Hand, where the camera observes the robot within its work space from an external point. The latter allows a larger field of view, so the end actuator cannot become out of range of the target feature. However, this possibility should be mitigated by the accuracy of localisation system developed to ensure that the vehicle 2 is within 3 cm of the previous layer deposition. Also, the control systems required for Eye-In-Hand are usually much simpler, as they do not need to account for significant offset. Moreover, an external fixed visual system would increase setup times and reduce mobility. For these reasons, the visual sensor is fitted to the end actuator.

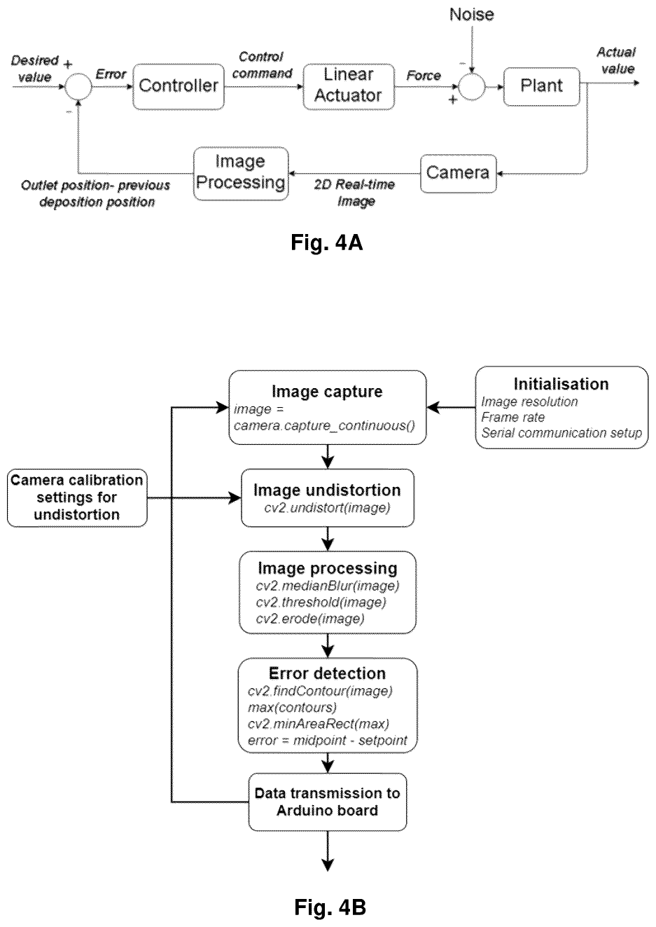

FIG. 4A is a block diagram of a visual servoing control system of the vehicle 2; and FIG. 4B is a flow diagram of the Raspberry Pi processing loop with the main functions described. Images were attained via a Raspberry Pi camera and were processed using a Raspberry Pi 3b+. The output of this was the value of the difference in position between the nozzle outlet and the previously deposited layer. This value was sent to the Arduino uStepper board that controlled the linear actuator, which converted this value into a translation command for the linear actuator to compensate for the difference. connector to one side, which allowed the nozzle outlet to be fixed, and in front of this the Pi camera was attached, as shown in FIG. 3D. The Raspberry Pi camera was fitted with a 160° fisheye lens to allow a wide field of view, ensuring the camera's ability to visualise the previous deposit at all times. Camera resolution was 5 MP, and recording occurred at 30 fps. All images were passed through the Raspberry Pi 3b+, which was installed with open source Computer Vision (OpenCV) version 3.0. OpenCV contained repositories for all image processing, specifically the OpenCV libraries dedicated to camera calibration, image undistortion, image processing and feature extraction. Image distortion was present largely due to the fisheye camera lens fitted. The presence of this radial distortion produced a ‘barrel’ or ‘fish-eye’ effect to the images received. The undistortion algorithm was utilised with the camera calibration module in OpenCV. Distortion coefficients were calculated during the calibration process and then applied to each frame taken from the camera during image processing. The system is composed of a Raspberry Pi Camera and 3b board that detect the geometrical characteristics of the previous depositions layer using image processing in OpenCV. Based on the information received and processed on the Pi, data will be sent to an Arduino board via a serial communication. This is transmitted in terms of the magnitude and direction of rotation for the stepper motor which actuates the slider by means of a belt, which converts the rotational motion into a translational one. This process is summarised in FIG. 4B, with some of main processing functions of each stage highlighted.

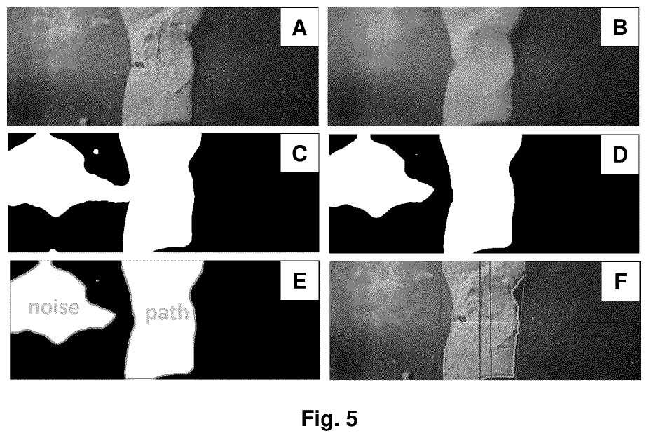

During operation each image individually recorded was processed according to the following six steps:
1. Image capture: the image was taken from the Raspberry Pi camera and undistorted producing a 2D image such as that shown in FIG. 5A.
2. Median blurring: noise from the image was then reduced by passing the image through the median blurring function in OpenCV. This effectively replaced the central element of the image with the median of all the pixels in the surrounding area. This was primarily used to remove impulsive noise, such as dust speckles from images. The images were also converted to grey scale during this stage, as shown in FIG. 5B.
3. Thresholding: this stage involved the partitioning of the image into a binary format. Pixels within a certain range, associated with the colour of the deposition, were converted to white, and all others were converted to black. This was not an entirely accurate process, as shown in FIG. 5C with glare from the light being detected as deposition. Fine tuning of this acceptable range was often optimised through testing, dependent on deposit type.
4. Erosion: this technique replaced each pixel intensity with the minimum intensity detected in its surroundings. This was utilised to better distinguish individual shapes and help reduce unwanted noise. The resulting more defined image is shown in FIG. 5D.
5. Contour detection: at this stage the contour detection function from OpenCV was used to detect separate features, as shown in FIG. 5E. It was assumed that the largest feature present was the feature of importance, e.g. the previous deposit.
6. Error detection: the final stage utilised the contour function to outline the shape of the detected deposition. As the camera centre was aligned with the nozzle outlet centre, the centre point of the detected deposition should align with the centre of the image. This is highlighted in FIG. 5F, where the blue lines represent the geometry of the detected pre-deposit, and centre lines of said geometry. The red line represents the centre point of the image, which coincides with the centre point of the nozzle outlet. The error was then calculated as the difference between these centre lines, which was then multiplied by 0.8 (the proportional gain chosen through testing) and used as a command for the linear actuator. The angle of the deposition was also transmitted, allowing the overall system to predict where the nozzle should be for future reference, before the next image was processed. The whole machine vision and closed-loop control for the linear actuator worked in real-time.

The visual-servoing system was fitted to the lower module of the rover system, as shown in FIG. 3C. An LED strip was also added to the underside of the chassis to allow illumination of the deposition, this was accounted for when processing the images.

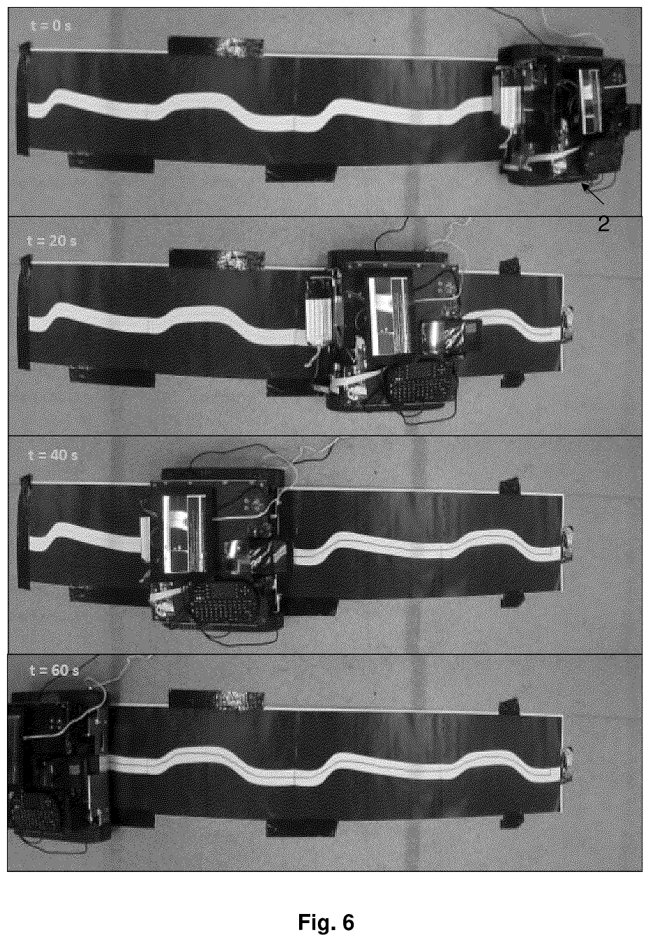

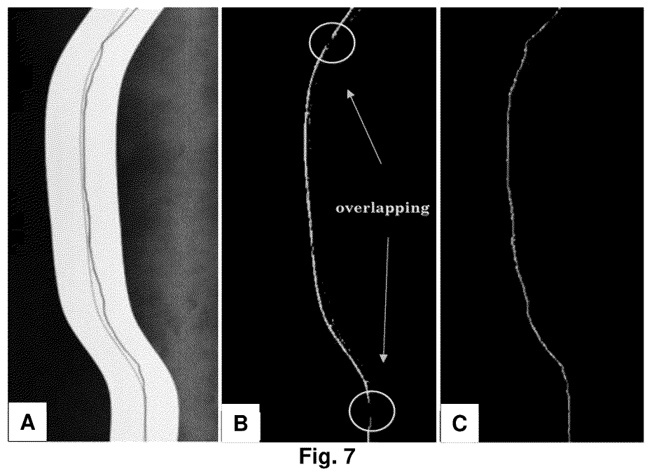

A deposition simulation was created using a sheet of paper containing a white path on a black background for simplicity. For initial testing, the rover system was programmed to travel along the sheet of paper at a constant speed of 0.01 m/s. The visual-servoing system was required to detect the white path and correct the actuator's position to ensure that it followed the centre of said path. The green line on said paper represented the exact centerline of the white region. A red marker pen was then fitted to simulate the nozzle outlet and visualise system accuracy on the sheet of paper. The results of this test are shown in FIG. 6. Note that the red marking overlaps with centerline almost exactly. Error estimation was conducted post experiment by the same system visually recording the green and red markings, this is shown in FIG. 7. The distance, if any, between the green centerline and the red marking was calculated as the error. The mean error for this experiment was 2.17 mm, with root mean square and standard deviation being 3.74 mm and 3.04 mm respectively. These values were more than sufficient for the purposes of depositing a layer on layer as the deposition width was in excess of 12 mm. However, errors did occur in tight turns, primarily because the proportional gain was not high enough to compensate for the large repositioning over short time steps. This could have been mitigated by integrating Integral and Differential terms in the PID controller, but this was deemed not necessary as tight turns were unlikely to occur for the style of straight line printing planned for this system.

As shown in FIG. 3C, the syringe deposition system was mounted on top of the mobile platform that housed all of the visual-servoing system. The extrusion control unit was interfaced with the visual-servoing system to ensure extrusion was initiated when detection of pre-deposition occurred, and stopped when such detection ended. The system was then tested on various simulated and real pre-deposition paths, as will be described in this section. Cement was chosen as the material for deposition as it is one of the most widely used materials for infrastructure due to its large compressive strength and low cost. The cement being used in the following demonstrations was a general purpose product (Mastercrete Cement, Blue Circle) with a low water demand, offering a more cohesive mix. The cement:water mix ratio determined the viscosity and final compressive strength of the deposit, and for the tests described in this section a mix ratio of 1:3.1 (by mass) was used. Such a choice provided a sufficiently high compressive strength for multi-layered stacks, while the viscosity was low enough to allow extrusion. The compressive strength was measured with a material testing machine (Instron 3369) loading the specimens, which were on average 10×10×10 mm, at a rate of 2 mm/min. Breakage occurred on average at a pressure of 16 MPa.

Single Layer Extrusion

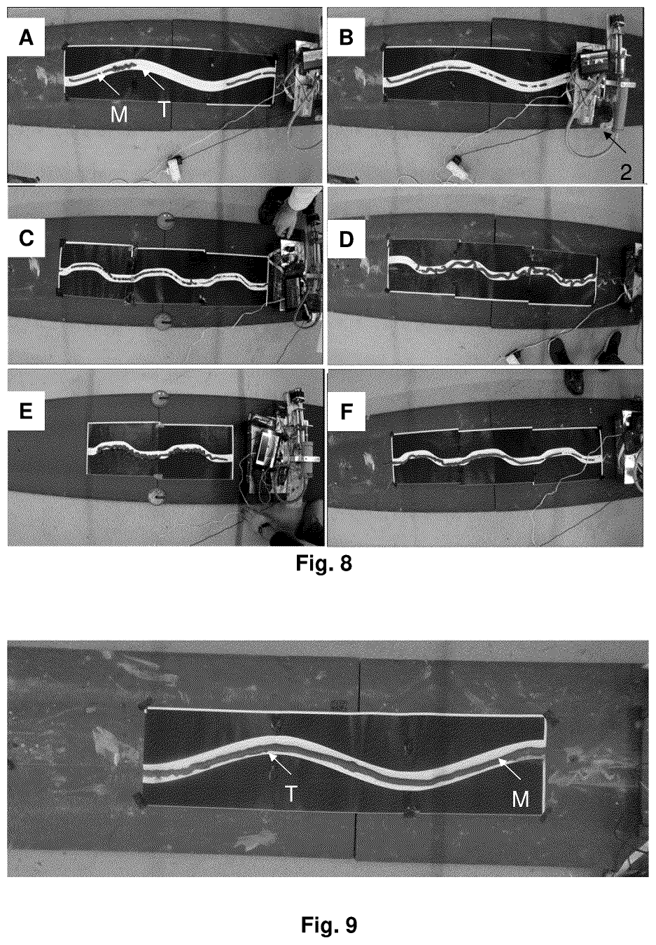

This first demonstration involved the system moving along a white path on a black background and depositing cement along the centerline of such path, similarly to the test described above. As before, the system was calibrated to detect the white path as extrusion. The initial results, shown in FIG. 8, highlight calibration errors for the system, primarily between extrusion rate and rover movement speed. The first attempts shown in FIG. 8A to C represent under extrusion from the depositor which led to either non-extrusion or thin stretched out trails. On the other hand, FIG. 8 D to E highlight over extrusion, with the deposit twisting along the deposition route. The final image, FIG. 8 F, shows a successful attempt of coordinating robot speed with extrusion rate. The visual-servoing system accurately maintained deposition within the centre of the simulates paths. The inner diameter of the tubing connecting the syringe to the outlet was increased to produce a larger deposition and resulted in more consistent, steady flow extrusion, as shown in FIG. 9. The reliable deposition allowed the successful validation of the image processing unit to initiate and stop printing when no path was detected. As shown, the visual-servoing system accurately tracked the white path ensuring that the nozzle outlet was consistently extruding in the centre of the path. This final extrusion measured roughly 10 mm high, 12 mm wide and 630 mm in length. This test was repeated several times to ensure consistent and robust deposition was achievable.

Multi Layer Extrusion

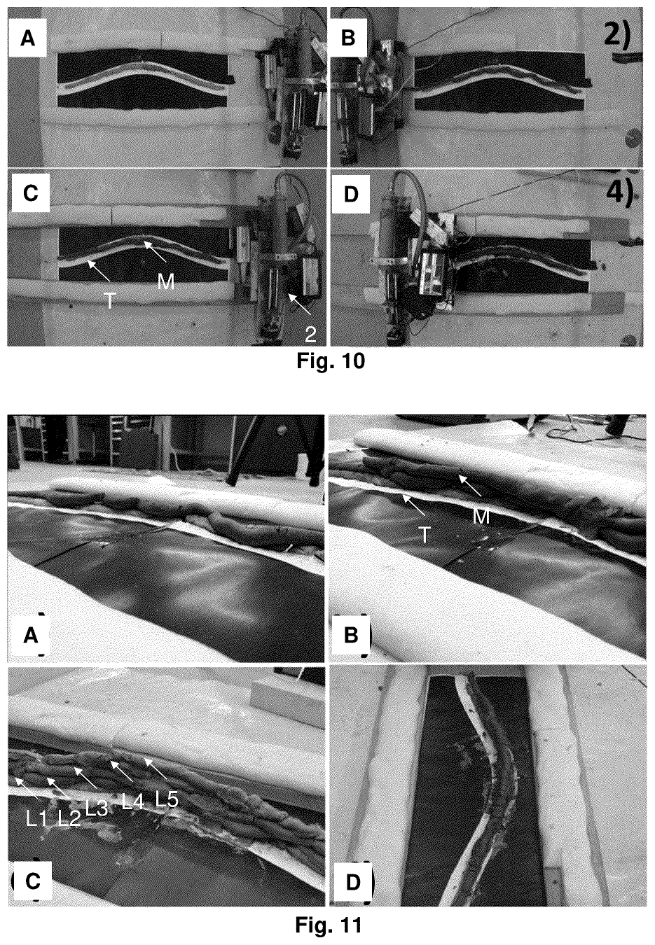

The previous demonstration showed that the extrusion and visual servoing systems provided accurate results on simulated pre-deposits. The second demonstration tested the system's capability in depositing cement on top of previously deposited cementitious tracks. This test aimed to deposit five consecutive layers of cement, without providing sufficient time to set between layers. A simulated pre-deposition was created to allow the first layer to print a pattern that would test the system's ability to accurately track the proceeding layers. The first layer utilised the same thresholding values as the previous test to detect the white path and extrude along it. Following the first layer deposition, shown in FIG. 10A, the visual servoing system was reconfigured to detect the grey threshold of the cementitious material, rather than the white background. Two foam ramp structures were installed manually to either side of the print, allowing the system to increase its altitude. The vehicle 2 was then programmed to move and print on the detected pre-deposit, as demonstrated in FIG. 10B. This process was repeated successfully for five layers, as shown in FIGS. 10C and 10D. The resulting five layered L1 to L5 print is shown in FIG. 11. These images highlight the visual-servoing system's ability to accurately detect and attain the position of previously deposited materials. Small inaccuracies (<4 mm) did occur, which are exacerbated as the deposit width was only around 12 mm. The total print height was 56 mm and the length was approximately 700 mm, but decreased with increasing layer numbers as there was a lag between deposit detection and extrusion. This resulted in decreasing deposit lengths with increased layer height. This could be mitigated through mounting the camera further along the platform or increasing processing speed of the Pi. However, this was a proof of concept and the final system would make use of extrusion dimensions far in excess of this value, where such small inaccuracies would be negligible on the scale of printing at tens of centimetres in width. This larger extrusion width would also increase the detectabilty of the previously deposited extrusion.

Damage Repair Validation

A further development and system validation was designed around surface damage detection and repair. The current platform was simply augmented to allow the detection and repair of crack-like damage (i.e. a deposition target T) in the ground. The visual-servoing system detected contrast to determine damage position and size, which was used to calculate the extrusion rate of the deposited cement. Two tests were designed to assess the effectiveness of the cement deposition and visual actuator system. These experiments required the rover to: i) detect the position of the gap using the vision system ii) ensure cement was deposited accurately within the gap, controlling both extrusion rate and position. The first test considered a straight line crack and the second a dynamic line crack (relative to rover centre).

Multi-Layered Straight Line Deposit

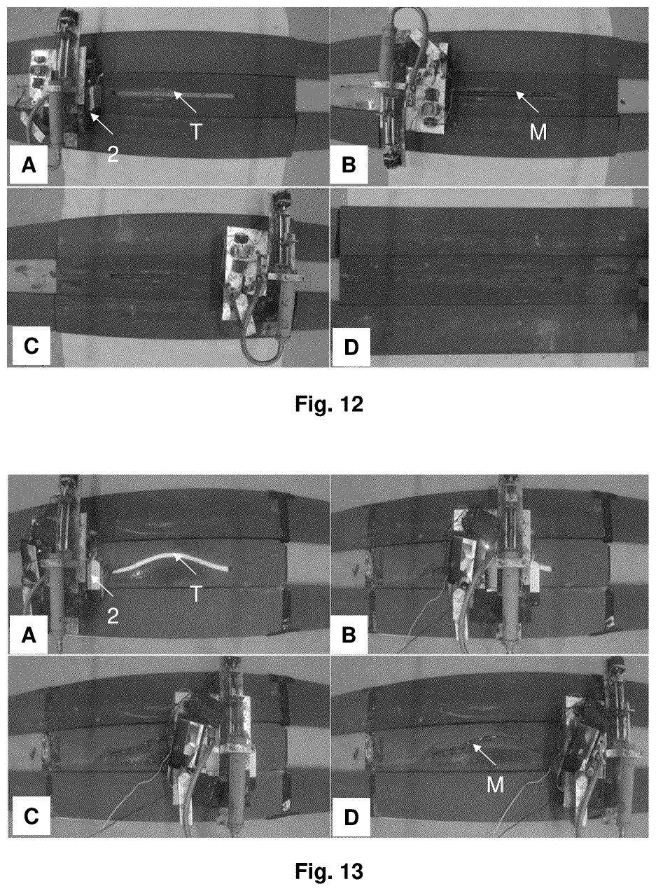

For this experiment a straight line crack was located along the rover's path. The rover travelled over said path multiple times, depositing several layers of cement until the crack was filled. The crack length, height and width were: 600 mm, 40 mm and 20 mm, respectively. As shown in FIG. 12, the rover accurately detected the crack 4 times. In the first run contrast was detected between the white base layer and the black top layer. For the subsequent layers, contract was detected between the grey cement and black top layer. This test validated that the detection system could accurately determine when and where to deposit. Total time for this experiment time was 5 minutes and 22 seconds.

Single Layer Dynamic Line Deposit

This test involved the rover travelling in a straight line above a crack that deviated from the rover centre, thus requiring the vision system to detect the crack propagation and control the actuator to ensure deposit occurred within the crack. The crack also changed width, testing the system's ability to control pump rate dependent on crack size. The total crack length and height for this experiment were: 650 mm and 15 mm, respectively. The crack width varied between a maximum of 25 mm to a minimum of 15 mm. As shown in FIG. 13, the rover accurately determined when to begin depositing. Initially, the amount of deposit was exact, but then the rover occasionally under deposited the cement, forming small gaps. This test demonstrated the ability of the vision and actuator system to appropriately follow the crack along its propagation path. Total time for this experiment time was 1 minute and 42 seconds.

Archimedes Screw Pump

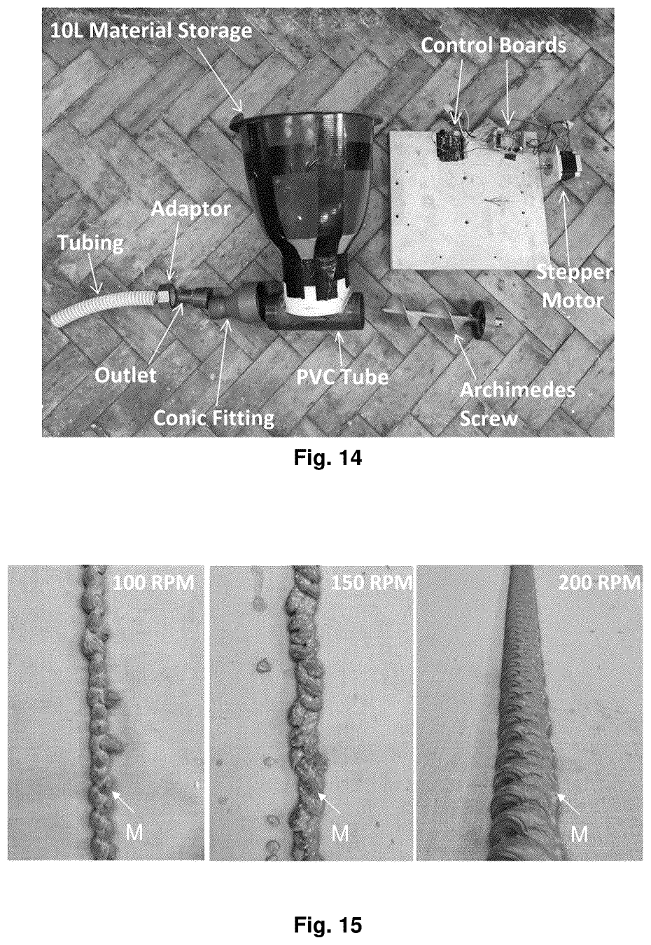

Following the successful development and integration of the syringe deposition system described above, the focus shifted designing an Archimedes screw based deposition device. The described syringe style pumping system had a total maximum capacity of 330 ml, which was sufficient for proof-of-concept demonstrations at this scale. However, the process of scaling a syringe pumping system to practical capacities would be challenging. The required increase in motor torque would be substantial, dramatically increasing power consumption and system weight. Moreover, the refilling process for the system was cumbersome and time-consuming. At increased capacities it would become infeasible to do so, which could affect the system's ability to self refill or even become fully autonomous. As discussed above, an Archimedes screw-style pumping system would overcome these issues, but require substantial development and fine tuning. Due to the complex material flow behaviour of a screw style pumping system for cementitious materials, an empirical design methodology was adopted. This empirical design methodology was primarily used to tune the tube length and diameter, outlet diameter and thread dimensions based on the material flow rate per screw/motor rotational speed. The final Archimedes screw-style pumping system developed is shown in FIG. 14. The system made use of a motor driven Archimedes screw which actuated material from the rear (motor side) to the outlet. Material was fed into the Archimedes screw from the 10L material storage system relying only on gravity. The conical fitting shown ensured gradual resistance to movement as the inner diameter reduced from 68 mm at the PVC tube down to 22 mm at the outlet. The angle of the cone gradient was approximately 30°, which allow sufficient material actuation per rotation. An important design consideration was the pitch and thread thickness of the Archimedes screw, these were 100 mm and 3 mm respectively and, as described, were determined through empirical testing. The total screw length was 200 mm and the outer diameter was parallel and designed to fit exactly within the PVC tube without touching the inner wall, which ensured maximum material displacement without any unnecessary loads on the motor. The motor itself was the same as that described for the syringe, with the reduction gear removed to ensure sufficient revolutions per minute (RPM), and therefore material output. The only limiting factor of the new pumping system was the increased total loaded weight, which was 21 kg, 11 kg more than the syringe style pumping system. However, the percentage of material weight to total loaded system weight was 71% for the screw pump and 5% for the syringe pump, highlighting its much greater overall efficiency. The primary benefit of this system was the much larger 10L material capacity, 30 times that of the syringe pump. The tubing ID was 30 mm, resulting in extrusion that was around 3× as wide as the syringe pump capabilities. These properties allowed far more substantial output, as highlighted in FIG. 15. For this demonstration the Archimedes pumping system was fitted to the vehicle 2. The system was tasked to simply move in a straight line for 6 m, turn and then return, following a path of roughly 13 m in total. During this demonstration the rover speed was fixed and pump rate was altered from 100 RPM for the first stage, to 150 RPM for the second stage and 200 RPM for the final stage. This demonstration highlighted the high volumetric output of the system compared to its relatively small size. During the demonstration the system was refilled once and therefore extruded 20L of cement in total. The full demonstration lasted around 8 minutes. The maximum output rate tested was around 5 L of cement per minute. However, higher output was possible as the motor torque was working at around 70% capacity for this. Moreover, the system showed that it was more robust to increased material viscosity than the syringe deposition system, as the cementitious material used for this demonstration was more viscous (the water:cement ratio was reduced by approximately 15%). Further, due to the increased outlet size, blockages were less likely to occur. The demonstration also highlighted the ease with which the new system could be refilled, increasing the likelihood for efficiency at scale. Related to this was the scaling potential of the system. As the material being driven was fixed to the capacity of the PVC tube, it was independent of the material reservoir that fed it. This could therefore be dramatically increased without major system redesigns. These same characteristic also allowed extremely simple modification for pump rate, which for this demonstration resulted in very different outputs, as shown in FIG. 15. All results were consistent, however, 200 RPM seemed to give the most steady pattern. The output for this was around 10 cm wide and 4 cm high and spanned for around 5 m. Overall, the Archimedes-screw pump solution had a much larger material capacity and output rate that the syringe based system, making it a viable candidate for the future development of the project. Further, as the extrusion system was independent of the material reservoir, the capacity could be increased without major redesign.

Vehicle

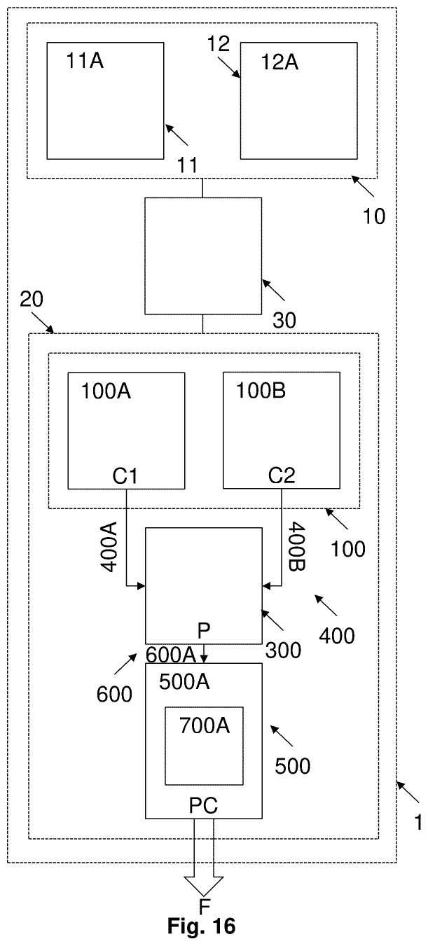

FIG. 16 schematically depicts a vehicle 1 according to an exemplary embodiment. The vehicle 1 is preferably an unmanned and/or autonomous vehicle, for example a robot. The vehicle 1 comprises: a propulsion system 10, arranged to propel the vehicle 1, comprising a set of wheels 11 including a first wheel 11A and/or a set of tracks 12 including a first track 12A; a deposition apparatus 20 for depositing a foam F comprising a polymeric composition PC; and a controller 30 arranged to control the deposition apparatus 20 and optionally, the propulsion system 10. The deposition apparatus 20 comprises a set of reservoirs 100, including a first reservoir 100A and a second reservoir 100B arranged to receive therein a first component C1 and a second component C2 of the polymeric composition PC, respectively; optionally a set of pumps 200 (not shown), including a first pump 200A (not shown) and a second pump 200B (not shown) arranged to pump the first component C1 and the second component C2 from the first reservoir 100A and the second reservoir 100B, respectively; a blending chamber 300 in fluid communication with the set of reservoirs 100 via a set of inlet passageways 400, including a first inlet passageway 400A and a second inlet passageway 400B, wherein the blending chamber 300 is arranged to blend the first component C1 and the second component C2 therein to provide a precursor P of the polymeric composition PC; and a set of deposition nozzles 500 in fluid communication with the blending chamber 300 via a set of outlet passageways 600 including a first outlet passageway 600A, the set of deposition nozzles 500 including a first deposition nozzle 500A comprising a static mixer 700A arranged to mix the precursor P to generate the foam F, at least in part, therefrom.

Example vehicle

This section describes the design of a foam mixing and depositing device (i.e. a deposition apparatus 20), the characterisation of the foam produced by this device and the integration with an autonomous ground tracked vehicle 2, generally as described with respect to the vehicle 1. Like reference signs denote like features.

In more detail, the vehicle 2 is an autonomous vehicle. The vehicle 2 comprises: a propulsion system 10, arranged to propel the vehicle 1, comprising a set of tracks 12 including a first track 12A and a second track 12B; a deposition apparatus 20 for depositing a foam F comprising a polymeric composition PC; and a controller 30 arranged to control the deposition apparatus 20 and optionally, the propulsion system 10. The deposition apparatus 20 comprises a set of reservoirs 100, including a first reservoir 100A and a second reservoir 100B arranged to receive therein a first component C1 and a second component C2 of the polymeric composition PC, respectively; a set of pumps 200, including a first pump 200A and a second pump 200B arranged to pump the first component C1 and the second component C2 from the first reservoir 100A and the second reservoir 100B, respectively; a blending chamber 300 in fluid communication with the set of reservoirs 100 via a set of inlet passageways 400, including a first inlet passageway 400A and a second inlet passageway 400B, wherein the blending chamber 300 is arranged to blend the first component C1 and the second component C2 therein to provide a precursor P of the polymeric composition PC; and a set of deposition nozzles 500 in fluid communication with the blending chamber 300 via a set of outlet passageways 600 including a first outlet passageway 600A and a second outlet passageway 600B, the set of deposition nozzles 500 including a first deposition nozzle 500A comprising a static mixer 700A and a second deposition nozzle 500B comprising a static mixer 700B arranged to mix the precursor P to generate the foam F, at least in part, therefrom. In this example, the first deposition nozzle 500A is arranged forwardly of the first track 12A. In this example, the second deposition nozzle 500B is arranged forwardly of the second track 12B. In this example, the first deposition nozzle 500A is arranged aligned with the first track 12A. In this example, the second deposition nozzle 500B is arranged aligned with the second track 12B.

In this example, the propulsion system 10 comprises a set of actuators 13, including a first actuator 13A and a second actuator 13B, arranged to actuate the set of tracks 12, particularly the first track 12A and the second track 12B respectively. In this example, the first actuator 13A and the second actuator 13B are motors, as described below.

In this example, the set of reservoirs 100 includes a third reservoir 100C arranged to receive therein a solvent for cleaning the blending chamber 300, the set of outlet passageways 600 and the set of deposition nozzles 500. In this example, the set of pumps 200 includes a third pump 200C arranged to pump the solvent from the third reservoir 100C and the set of inlet passageways 400 includes a third inlet passageway 400C.

In this example, the vehicle 2 comprises a set of sensors 800 including a first sensor 800A arranged to sense an obstacle O and to transmit a first signal to the controller 30, in response to sensing the obstacle O. In this example, the first sensor 800A is a proximity sensor, particularly an ultrasonic sensor. In this example, the first sensor 800A comprises an array of ultrasonic sensors.

In this example, the controller 30 comprises a processor and a memory and is arranged to control the deposition apparatus 20 and optionally, the propulsion system 10, according to software (i.e. programmatic instructions executed by the processor). In this example, the controller 30 is arranged to receive the first signal transmitted by the first sensor and to control the propulsion system 10 and/or the deposition apparatus 20, based, at least in part, on the received first signal. In this example, the controller 30 is arranged to control the propulsion system 10 to move the vehicle 2 rearwardly or forwardly and to control the deposition apparatus 20 to deposit the foam F, based, at least in part, on the received first signal. In this example, the controller 30 is arranged to control the propulsion system 10 to move the vehicle 2 rearwardly and to control the deposition apparatus 20 to deposit the foam F, based, at least in part, on the received first signal, while the vehicle 2 moves rearwardly. In this example, the controller 30 is arranged to control the deposition apparatus 20 to deposit the foam F, based, at least in part, on a distance from an obstacle O, for example as determined from the received first signal. In this example, the controller 30 is arranged to control a rate of deposition of the foam F by the deposition apparatus 20, based, at least in part, on a distance from an obstacle O, for example as determined from the received first signal. In this example, the controller 30 is arranged to control the propulsion system 10 to move the vehicle 2 forwardly after depositing the foam F. In this example, the controller 30 is arranged to control the propulsion system 10 and/or the deposition apparatus 20 to repeatedly move the vehicle 2 and/or deposit the foam F. In this way, the vehicle 2 may overcome a relatively larger obstacle O. In this example, the controller 30 is arranged to control the propulsion system 10 to move the vehicle 2 forwardly and to control the deposition apparatus 20 to deposit the foam F, based, at least in part, on the received first signal, optionally while the vehicle 2 moves forwardly. In this example, the controller 30 is arranged to control a speed of the set of pumps 200, for example respective speeds of the first pump 200A and the second pump 200B, as a function of time. In this example, the controller 30 is arranged to control a speed of the set of pumps 200, for example respective speeds of the first pump 200A and the second pump independently 200B. In this example, the controller 30 is arranged to calculate a distance from the object O, based, at least in part, on the first signal. In this example, the controller 30 is arranged to calculate a depth and/or a volume of a void, such as a chasm, based, at least in part, on the first signal. In this example, the controller 30 is arranged to calculate an amount of the first component C1 and/or the second component C2 to be deposited as the polymeric composition PC based, at least in part, on the first signal, for example by using the volume of the void to be filled and an expected expansion of the foam F.

Deposition Apparatus

PU is a synthetic resin composed of polymer units linked by urethane groups. The two part constituents must be combined with enough vigour for reaction, upon doing so the mix quickly expands and then sets rigid. Expansion typically occurs within 30-50 seconds and solidification may take up to 8 minutes. The final mechanical properties of the PU foam are significantly affected by the mix ratio of the two constituent parts, and therefore can be tuned with relative ease. Compressive strengths of over 2 MPa are possible, so that the solidified foam can easily support the weight of a human standing on it. Expansion ratios of over 30× the original volume are viable, meaning that 25 dm³ of solidified foam can be generated from just 0.84 dm³ of the two part liquid constituents. These values depend largely on the mixing style and have been recorded through testing on the proposed system, as discussed below. The foam in its final state is closed-cell, water-proof and lighter than water yet, as mentioned, still strong enough to support the weight of a human climbing thereon. Additionally, these foams adhere to a wide variety of materials including wood, iron, and concrete, among others. Based on these characteristics, this material is suitable for use in disaster scenarios in real-time.

The foam was generated from POLYCRAFT PU5800 (available from MBFibreglass, UK), provided as a two-part pack comprising POLYCRAFT PU5800 PART A and POLYCRAFT PU5800 PART (i.e. the first component C1 and the second component C2 of the polymeric composition PC, respectively). POLYCRAFT PU5800 PART A comprises DIPROPYLENE GLYCOL (CAS 110-98-5) 1-25% and N,N,N′,N′-TETRAMETHYL-2,2′-OXYBIS(ETHYLAMINE) (CAS 3033-62-3) 0.05-1% by volume. POLYCRAFT PU5800 PART A comprises DIPHENYLMETHANE DIISOCYANATE (ISOMERS AND HOMOLOGUES) (CAS 9016-87-9).

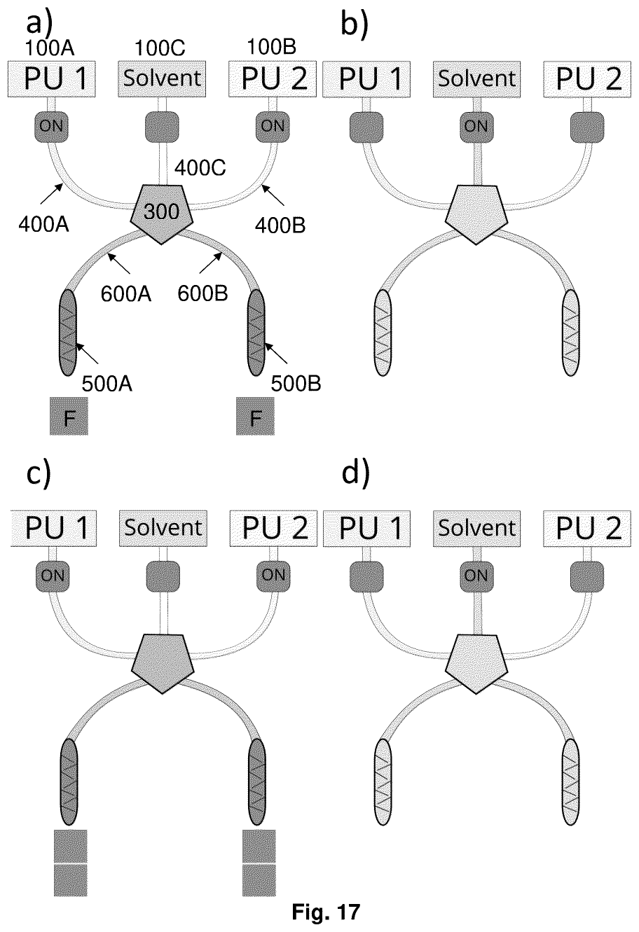

Peristaltic pumps (i.e. the first pump 200A and the second pump 200B) (9QX Peristaltic Pump 24V 3 Roller Stepper Motor available from Boxer GmbH, Germany) are used to drive PU part one and two (i.e. part A and part B) from their separate reservoirs (i.e. the first reservoir 100A and the second reservoir 100B, respectively) to the blending chamber 300 via respective inlet passageways (i.e. the first inlet passageway 400A and the second inlet passageway 400B) (Tubing type: PHI 3.5×5.6 mm, 1.05 mm wall available from Boxer GmbH, Germany). This blending chamber 300 ensures the two parts have been thoroughly mixed without increasing the turbulence to such an extent that the parts begin reacting. This mixing is necessary as multiple outlets may be required, and the viscous nature of the individual parts would otherwise make them flow without mixing. The now combined PU (i.e. the precursor P) is split across different channels (i.e. the first outlet passageway 600A and the second outlet passageway 600B) and passed through static mixing nozzles (MA6.3-21S, Adhesive Dispensing Ltd, UK) before being ejected at the outlets (i.e. the first deposition nozzle 500A and the second deposition nozzle 500B). A major drawback of conventional apparatuses is the blockage that occurs between uses, and even during use. This happens as residues, if not treated, will be left in the system and particularly in the static mixing nozzles. As the parts begin to react they become very adhering and as they expand often cause channels to become completely blocked. For the system, a solvent (isopropyl alcohol), driven by a third peristaltic pump (i.e. the third pump 200C) (9QX Peristaltic Pump—DC/Gear Motor 520 rpm 12V-3 roller available from Boxer GmbH, Germany), is then autonomously flushed through the set of inlet passageways 400, the blending chamber 300, the set of outlet passageways 600 and the set of deposition nozzles 500 at the end of each depositing phase to stop the reaction and eject any residue. This allows the deposition apparatus 20 to be used multiple times without blockage or manual intervention. The whole process is illustrated in FIG. 2. In more detail, FIG. 17 illustrates the stages of pumping PU part one and two to create PU foam and the solvent flush stages: a) pumping of PU part one and two to create first batch of PU foam; b) flush of solvent to ensure no blockages after use; c) pumping of PU part one and two to create second batch of PU foam; d) flush of solvent. Peristaltic pumps are represented by red symbols, central pentagon represents the mixing chamber and crossed cylinder represent the static mixing nozzles.

Driving the system with independent peristaltic pumps produces several advantages over current systems. Firstly, the amount of liquid being driven at any point is equal to the volume inside the tubing and mixing devices and is thus independent of the size of the reservoir from which it is being pumped. This implies that the flow generated by the pump is not affected by the size of the reservoirs, unlike conventional deposition apparatuses, and therefore the system can be significantly scaled without redesign, allowing large amount of material deposition.

Furthermore, the system can control the flow rate of each pump independently so that the ratio between PU Part one and Part two can be easily controlled. Such ratio controls the properties of the solidified foam, as previously mentioned. For example, if the system required a harder deposit, it could autonomously increase the ratio of PU Part one to the mix. Likewise, increasing the ratio of PU Part two would increase expansion ratio; this could be necessary if maximising the volumetric output was required. Additionally, increasing overall flow velocity increases the turbulence during the mixing of chemicals, thus reducing the time taken to begin expansion. This has the potential to allow the deposited material to be less fluid-like and immediately sticky, with obvious applications for foam deposition on vertical surfaces or gradients. Alternatively, making the deposited material more liquid-like on exit allows deposition into crevices and cracks for structural stabilisation. These options would not be possible for current state of the art syringe or aerosol depositing systems. However, increasing the rate of reaction above a certain level makes the substance more likely to block the static-mixers and thus a maximum overall pump speed is set to prevent this. Finally, the system allows the pumps to drive the liquids to two outlets, although it is possible to increase this number.

Foam Characterisation

Four different PU foams obtained via the proposed depositing device are characterised in this section in terms of their most relevant properties: mix ratio, expansion ratio, initial compressive strength, final compressive strength, rise time and set time. Note that the values reported for these four PU foams do not represent the upper and lower limits for properties such as compressive strength and expansion ratio. However, mixes that result in higher expansion ratios result in compressive strengths that may be too low for the deposit to be considered useful for structural applications but may be useful for insulation or buoyancy, for example. Conversely, mixes that result in lower expansion ratios result in compressive strengths that may be sufficient for the deposit to be considered useful for structural applications but may be less useful or non-economic for insulation or buoyancy, for example. In other words, a desired ratio may be selected for a particular application, to balance mechanical properties such as compressive strength, physical properties such as density, thermal properties such as thermal conductivity, curing time and/or cost.

Mix ratio considers the volumetric ratio between PU foam Part one and Part two, and it is controlled via the pump rates of the peristaltic pumps. Expansion ratios were measured by depositing the PU foam into a container and comparing the initial height of the deposited foam, with the final height of the deposited foam after the expansion had occurred. This method provides conservative estimates of expansion ratios as deposition in free space (e.g. on a surface exposed to air) allows more oxidation to occur, and therefore more expansion. However, depositing on a free surface would make it impossible to have consistency due to the different shapes assumed by the deposit.

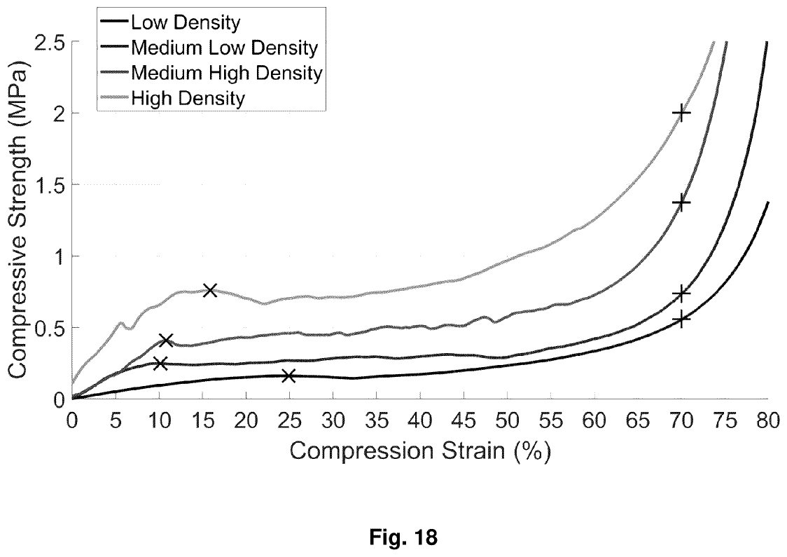

Typically, maximum compressive strength considers the amount of force applied per unit area until a material fails, where failure is often defined by the material cracking. However, PU foam, unlikely many solid materials, will continue to deform with sufficient pressure without breakage. Therefore, two alternative definitions of compressive strength are used here: initial compressive strength and final compressive strength. The former is defined as the pressure applied before permanent plastic deformation occurs, and is highlighted with the symbol ‘X’ in FIG. 18. FIG. 18 shows stress-strain curves of the foam for different mix ratios, see also Table 2. Final compressive strength is defined as the pressure at which the height of the deposit is reduced by 70%, as shown in FIG. 18 with the symbol ‘+’ Beyond this point the deposit is considered useless for overcoming obstacles.

Rise time is measured from initial deposition until final expansion has occurred. Finally, set time is measured from initial deposition until the foam has fully solidified, this is done by comparing stiffness until it is deemed the material is no longer solidifying and the material is immediately tested in the Instron machine (INSTRON 3345) loading the specimens at 2 mm/min. More importantly than the absolute values of the properties measured for the different PU foams are their relative differences, as they prove that the proposed deposit system can easily control the properties of the deposited material. A summary of properties of the deposited foams are reported in Table 2, where each foam is defined by the mix ratio of Part one to Part two.

TABLE 2
Characterisation of four types of PU foam.

| | Low | Medium-Low | Medium-High | High |
|---|---|---|---|---|
| | Density | Density | Density | Density |
| Mix Ratio (one:two) | 1:0.74 | 1:1 | 1:1.4 | 1:1.6 |
| Expansion Ratio | 33x | 29x | 25x | 20x |
| Initial Compressive | 0:16 | 0:25 | 0:41 | 0:76 |
| Strength (MPa) | | | | |
| Final Compressive | 0.56 | 0.74 | 1:37 | 2 |
| Strength (MPa) | | | | |
| Rise Time (s) | 37 | 46 | 52 | 55 |
| Set Time (s) | 210-270 | 240-300 | 270-340 | 310-380 |

Robotic Platform

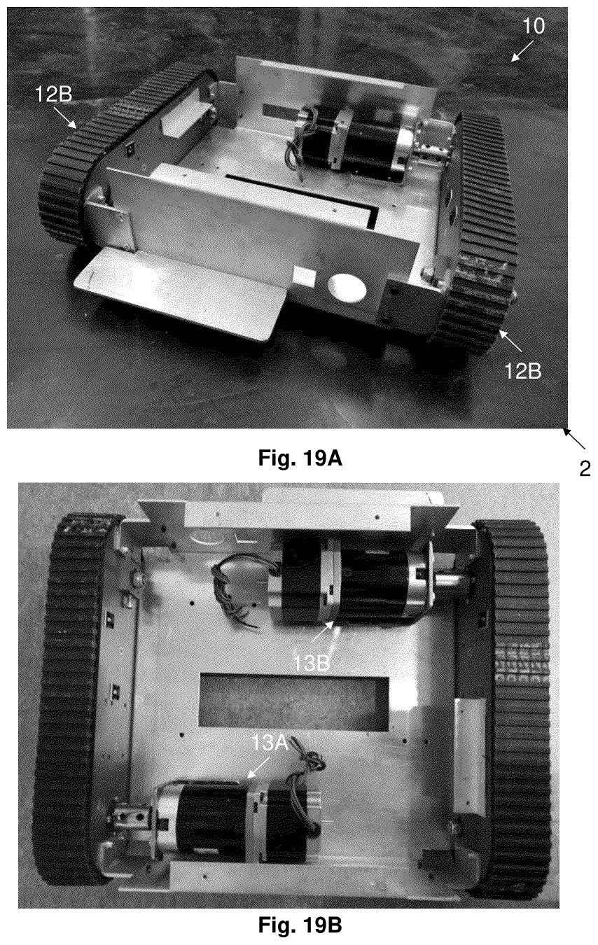

The PU depositing system has the potential to be combined with any existing robotic platform to extend its ability. For the purposes of testing, the simple low cost ground rover (i.e. the vehicle 2) shown in FIGS. 19A and 19B was used.

This platform is a two-tracked vehicle with a track height of 100 mm and a track length of 300 mm. The rover has a pressure value of 0.02 MPa (15 kg rover on the total surface area of its tracks), making any of the earlier defined foams suitable for the platform. The platform is driven by two large stepper motors (RB-Phi-266, Robotshop), which would allow a 50 kg payload to be pulled along an even medium friction surface. The rover is driven by a central Arduino Mega 2560 board (i.e. the controller 30) which controls the motor speeds via two Arduino Nano boards and the pumping systems via another Arduino Mega 2560. A digital compass is connected to the central control board to feed orientation information back to the controller and positional information is calculated from the localisation system, as described below. The PU foam depositing system was mounted on top of the rover with the two outlets positioned directly behind the tracks. As the rover moves, the foam will be deposited, forming two distinct extrusions which are aligned with the rovers tracks. Once the foam has expanded and solidified, the rover can simply climb on said extrusions to increase or maintain altitude. When depositing foam in a straight line, controlling either deposit speed or rover speed allows the platform to create ramp structures, as described below.

Experimental Setup

Two main experiments are designed to demonstrate the effectiveness of the proposed PU foam depositing system: obstacle climbing and chasm traversing.

Sensing and Depositing Strategies

Ultrasonic distance sensors (HC-SR04) are utilised to determine the presence of obstacles or chasms in front of the vehicle. If an object is detected, a ramp construction procedure is initiated, whereas a void filling function is executed if a chasm is present.

Frontal Object Detection

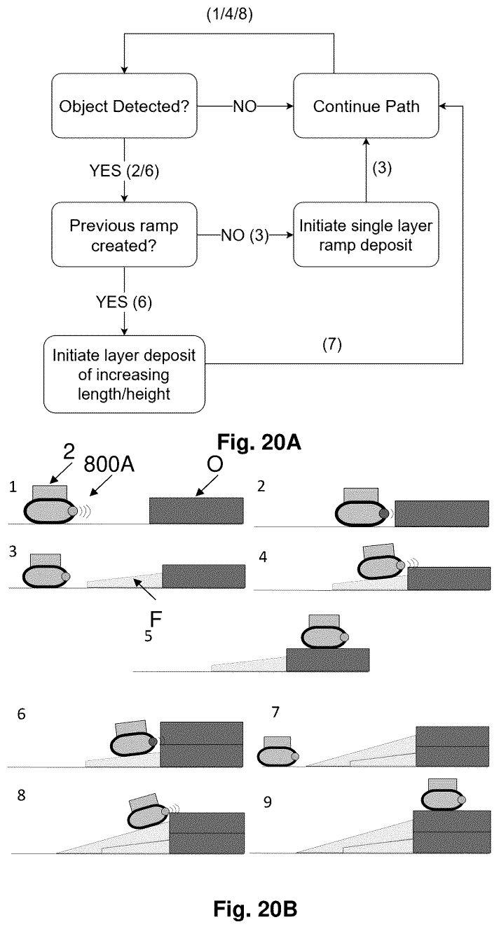

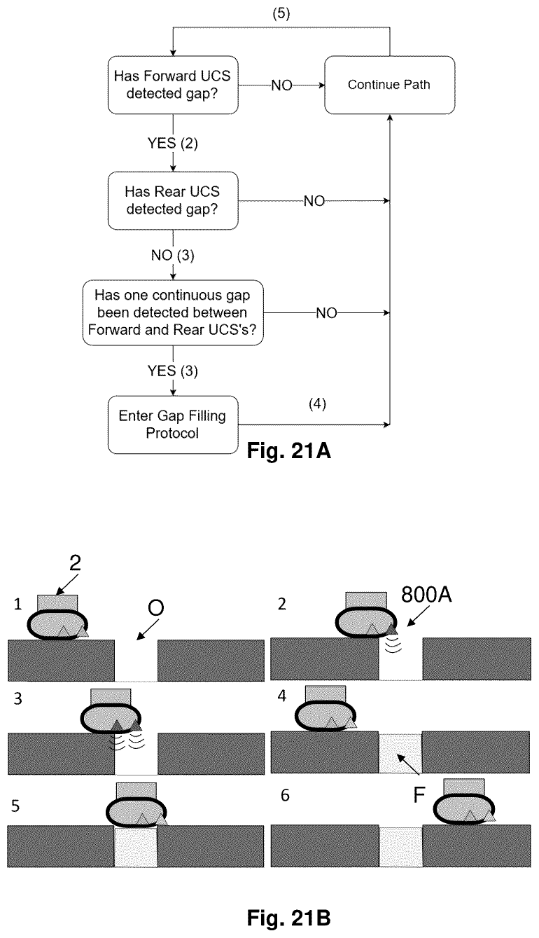

One sensor is placed at the front of the rover, at just above half of the rover track height. It was determined through testing that if an object is detected at this height or above, the rover will not be able to overcome it independently. As the rover cannot sense if the object is perpendicular to its path, once the object is detected, the rover will begin to move forward at a low motor torque to align the rover front face with the straight edge of an object upon contact. Once the frontal face of the rover has been aligned with the object, the depositing protocol will begin. For this, predetermined deposit rate/time sequence is initiated that will produce a ramp that allows the rover to overcome an obstacle at half of the rover track height. Testing was done to determine the maximum ramp angle for the rover, the deposit sequence ensures that the angle of the ramp is well below this threshold. Delays are also preset to ensure full foam set and curing time. If an obstacle is detected after climbing on this deposit, then the same procedure will be repeated, but with increased ramp length, thus ensuring angle of ramp below maximum ramp angle. The rover can overcome minor over/under expansions for frontal obstacles that may occur. The ramp building protocol, described in the flowchart of FIGS. 5A and 5B is then initiated, giving rise to the responses illustrated in the same figure. FIG. 20A Flowchart and FIG. 20B are illustrations of the frontal object detection system and ramp building

Chasm Detection

The chasm detection scenario considers detecting large gaps in the floor preventing path following. The rover used for testing can overcome chasms of up to 100 mm (one third of the total length) without falling into said gap, but longer gaps would prevent its motion. To address this challenge, two sensors are placed on the undercarriage of the chassis, facing the ground: one is positioned at the front of the rover and other at around one third of the rover length from the front. If both forward and centre undercarriage sensors detect a continuous gap, the rover will stop moving and initiate a void filling procedure. At first, the rover uses depth measurements of the chasm to estimates the amount of deposit required. However, if it under deposited (for example if the chasm was not uniform and larger than expected) then it would once again detect the chasm and repeat the filling procedure. Over-depositing typically leads to foam overflowing the chasm, but the extra amount is usually trivial for the rover to overcome. A flowchart of autonomous response to chasms and respective illustration for the responses are shown in FIGS. 6A and 6B. Chasm detection is overridden when climbing a ramp produced by the system.

Localisation Platform

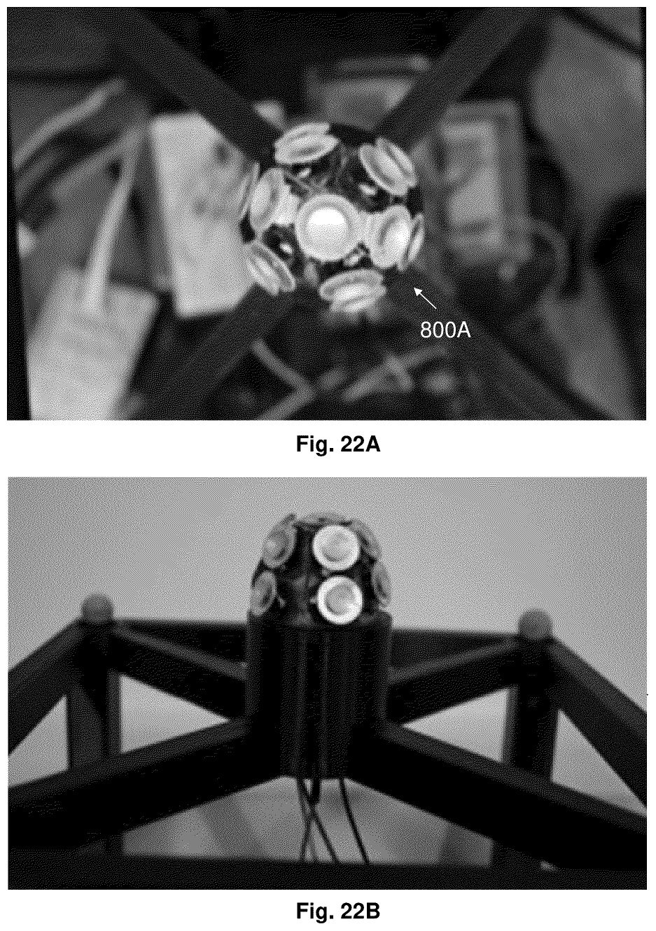

During the experimental tests the rover is tasked with following a desired path within a 4.3 m by 3.1 m arena and the obstacle avoidance protocols described above activate if said path is being blocked. To perform path following, a low-cost localisation system based on ultrasonic sensing and time difference of arrival was designed. The compact ultrasound emitter shown in FIGS. 22A and 22B was designed to generate omnidirectional train of ultrasound pulses which are then picked up by several fixed receivers measuring the time difference of arrival. A least squares approach is used to analytically obtain a first estimate of the emitter position, which is then refined through steepest descent optimisation. All processing is done via a standard Arduino platform, proving the low computational demands of the method. Localisation results have been validated against a state-of-the-art Optitrack motion capture system composed of 8 Prime17W cameras, to validate onboard determination of the rover, using the onboard ultrasound localisation system, against the external motion capture system. The ultrasound localisation system allows estimation of rover position within an accuracy of better than 3 cm over 89% of arena and better than 1 cm over 43% of the arena. Overall, the mean localisation error is 1.57 cm and the average standard deviation is 1.39 cm throughout the arena, making it suitable for being embedded on the mobile robotic platform used for the experiments.

Three experiments were carried out with both detection systems being operational. The rover is given a straight line path to follow, but if any object is detected along this path the vehicle must work out how best to overcome it. All three experiments require the ability to: i) detect an obstacle that prevents the rover from following the planned path ii) eject the PU foam correctly iii) flush the system to ensure no blockages occur iv) wait until the foam has cured and then overcome obstacle using the deposited foam. The first two experiments consider frontal obstacles and the third considers chasm detection. For all three tests the mix ratio of PU Part one:Part two was fixed at 1:1 (Medium-Low Density foam) so that it can settle within 6 minutes, expand around 29× and have sufficient strength to support the rover weight. All three of these obstacles have been tested to ensure that the rover could not overcome them without using the PU depositing system: with the rover toppling/not able to grip onto the material for the frontal objects or getting stuck in the chasm. Total run time is taken from the moment the object is detected until the time the object has been fully overcome (the entire rover is atop the object or passed the chasm).

Small Frontal Object Test

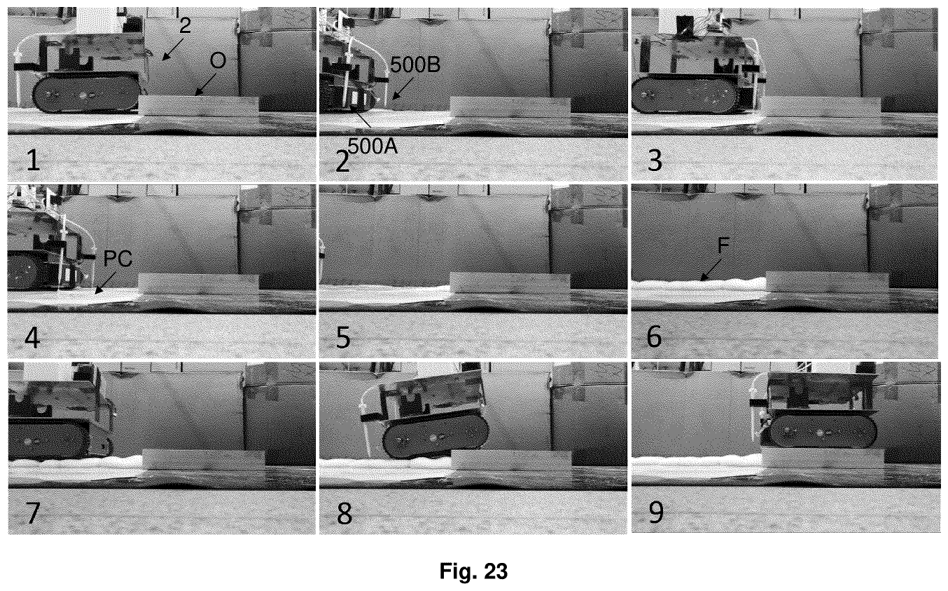

In the first experiment, a 60 mm high block −60% of the 100 mm rover height—was placed along the desired path. The rover detected the object, aligned itself and began the ramp deposit procedure. The vehicle created the ramp by varying pump speed as it moved away at a constant speed so that more material was deposited closer to the object, as shown in FIG. 23. The platform then waited for the foam to expand and solidify before using the deposit to continue its path. No further obstacle was detected and the rover could successfully climb onto the object. The total time to run this experiment was 6 minutes and 42 seconds.

FIG. 23.1: The vehicle 2 approaches the obstacle O (i.e. the 60 mm high block).

FIG. 23.2: The vehicle 2 moves away from the obstacle O and turns around, such that the set of deposition nozzles 500 face the object O.

FIG. 23.3: The vehicle 2 moves towards the obstacle O, senses the obstacle O and stops.

FIG. 23.4: The vehicle 2 moves rearwardly while depositing the PU foam F as two lines, the rate of depositing decreasing as the vehicle 2 moves further away from the obstacle O.

FIG. 23.5: The deposited PU foams to provide the foam F.

FIG. 23.6: The deposited PU continues to foam, defining a ramp, and cures.

FIG. 23.7: The vehicle 2 climbs the ramp and moves towards the obstacle O.

FIG. 23.8: The vehicle 2 climbs from the ramp onto the obstacle O.

FIG. 23.9: The vehicle 2 is fully on the obstacle O.

Large Frontal Object Test

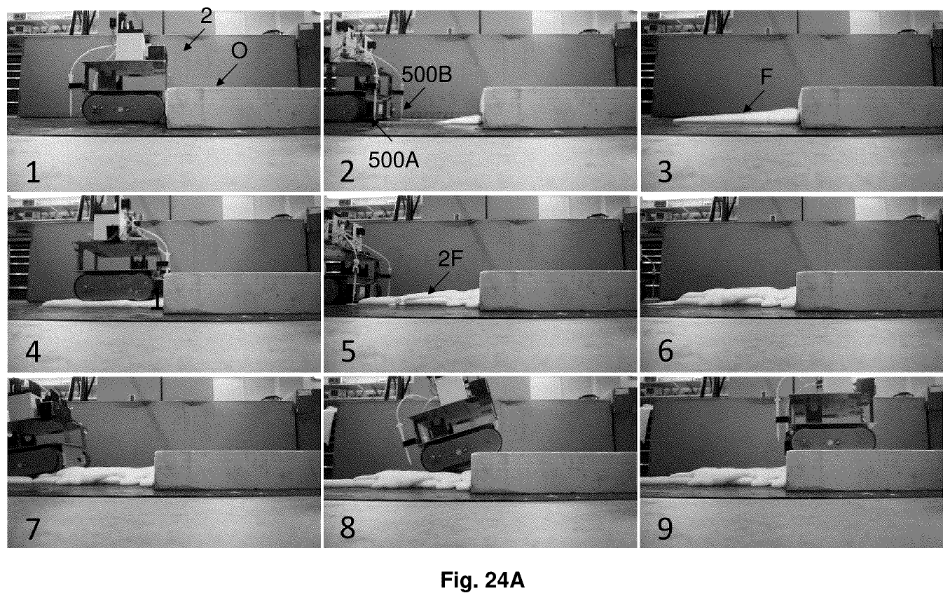

In the second experiment, a 130 mm high block −130% times the rover height—was placed along the planned path. The rover detected the object and conducted the same first layer ramp deposit procedure as in the previous experiment. However, upon climbing the ramp it detects the object again. Knowing it has previously deposited a ramp, the rover initiates the ramping procedure but deposits foam for an increased distance compared to the previously created ramps. The platform then waited for the second layer to cure and was able to overcome the object, as shown in FIGS. 24A and 24B. The success of this test proves that building large, multi-layered ramp structures is possible and that the system ensures no blockages occur between layers/uses. Total time for this experiment was 13 minutes and 42 seconds.

FIG. 24A.1 and FIG. 24B.1: The vehicle 2 approaches the obstacle O (i.e. the 120 mm high block).

FIG. 24A.2 and FIG. 24B.2: The vehicle 2 moves towards the obstacle O, senses the obstacle O and stops. The vehicle 2 moves rearwardly while depositing the PU foam F as two lines, the rate of depositing decreasing as the vehicle 2 moves further away from the obstacle O.

FIG. 24A.3 and FIG. 24B.3: The deposited PU foams to provide the foam F. The deposited PU continues to foam, defining a ramp, and cures.

FIG. 24A.4 and FIG. 24B.4: The vehicle 2 climbs the ramp, moves towards the obstacle, senses the obstacle O and stops.

FIG. 24A.5 and FIG. 24B.5: The vehicle 2 moves rearwardly while depositing a second layer of PU foam F2 as two lines on top of the previously-deposited foam F, the rate of depositing decreasing as the vehicle 2 moves further away from the obstacle O, repeating steps 9.2-9.4 for longer time/distance to create a longer ramp.

FIG. 24A.6 and FIG. 24B.6: The deposited PU foams to provide the foam F2. The deposited PU continues to foam, defining a higher ramp, and cures.

FIG. 24A.7 and FIG. 24B.7: The vehicle 2 climbs the ramp and moves towards the obstacle O.

FIG. 24A.8 and FIG. 24B.8: The vehicle 2 climbs from the ramp onto the obstacle O.

FIG. 24A.9 and FIG. 24B.9: The vehicle 2 is fully on the obstacle O.

Chasm Test

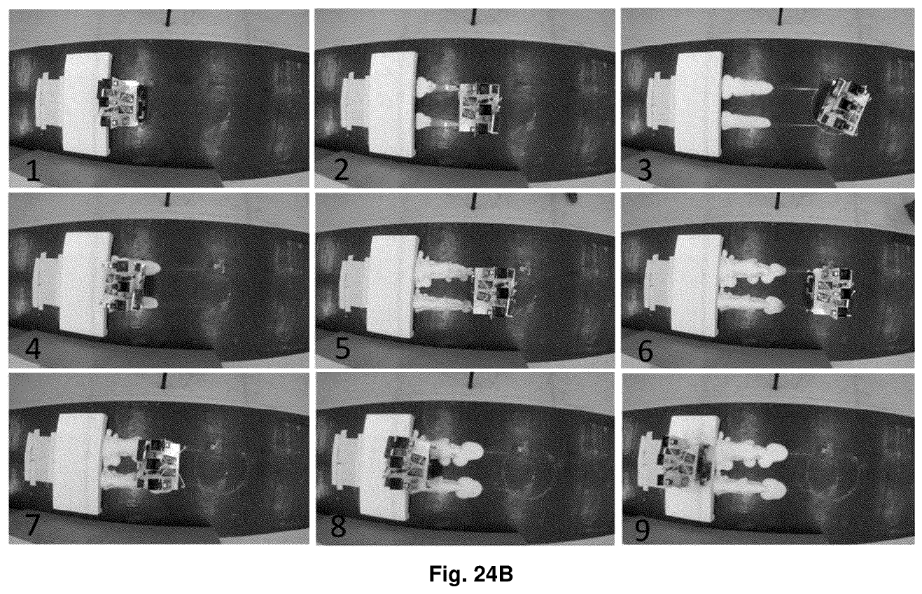

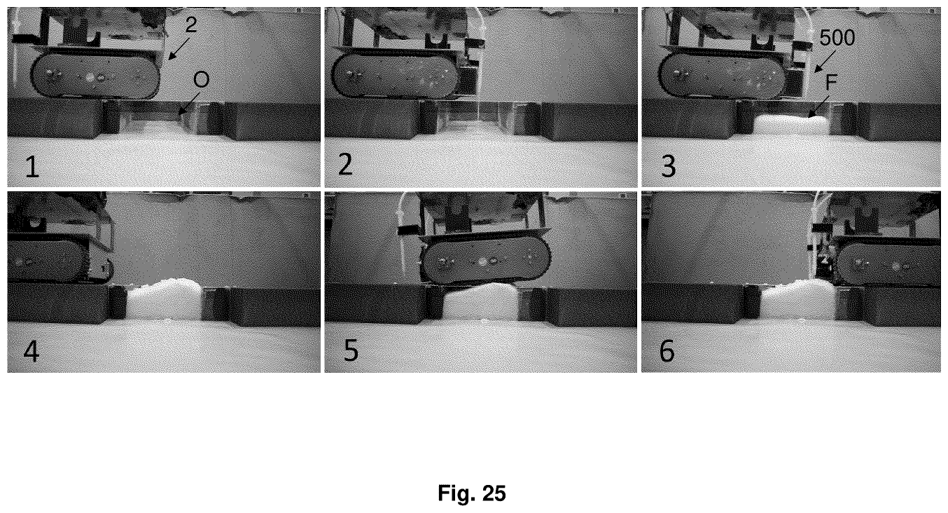

In the final experiment a 160 mm long chasm was placed along the rover's path, over half the 300 mm rover tracks length. The chasm was 80 mm deep and 400 mm wide. When the rover detected a small gap with the frontal undercarriage sensor, it reduced its speed to ensure it had sufficient time to either detect whether it was able or not to overcome the chasm without depositing material. Once the rover detected that the chasm was too long by using both undercarriage sensors, it started its gap filling procedure. The material depositing system estimated the amount of material to be deposited from the knowledge of the depth of the chasm (measured by sensors), performed the deposit and then waited for this to expand and solidify. The rover successfully filled the chasm and traversed the gap as shown in FIG. 25. Total time for this experiment time was 5 minutes and 50 seconds.

FIG. 25.1: The vehicle 2 approaches the obstacle O (i.e. the chasm), senses the obstacle O and stops.

FIG. 25.2: The vehicle 2 moves away from the obstacle O and turns around, such that the set of deposition nozzles 500 face the object O.

FIG. 25.3: The vehicle 2 deposits the PU foam F into the obstacle O.

FIG. 25.4: The deposited PU foams, filling the chasm, and cures.

FIG. 25.5: The vehicle 2 moves over the foam F, traversing the obstacle O.

FIG. 25.6: The vehicle 2 has traversed the obstacle O.

Blending Chamber

FIG. 26A is a CAD perspective view and FIG. 26B is a schematic cross-sectional view of a blending chamber 300 of the deposition apparatus 20 of the vehicle 2 of FIGS. 19A and 19B. In this example, the blending chamber 20 comprises a set of spherical chambers 310, including a first chamber 310A and a second chamber 310B, both having internal radii of 6 mm, for example a pair thereof of mutually interconnecting chambers, particularly indirectly interconnecting via an interconnecting passageway 320. In this example, the set of inlet passageways 400 (400A, 400B, 400C) have an internal diameter of 2 mm and are fluidically coupled to the first chamber 310A. In this example, the set of outlet passageways 600 (600A, 600B) have an internal diameter of 2 mm and are fluidically coupled to the second chamber 310B. In this example, the interconnecting passageway 320 has an internal diameter of 4 mm, smaller than a diameter of the first chamber 310A and the second chamber 310B. In this example, the blending chamber 20 does not comprise a static mixer, for example a helical static mixer or a plate-type static mixer. In this example, the blending chamber 20 comprises smooth internal walls, without any protuberances therefrom.

Deposition Nozzle

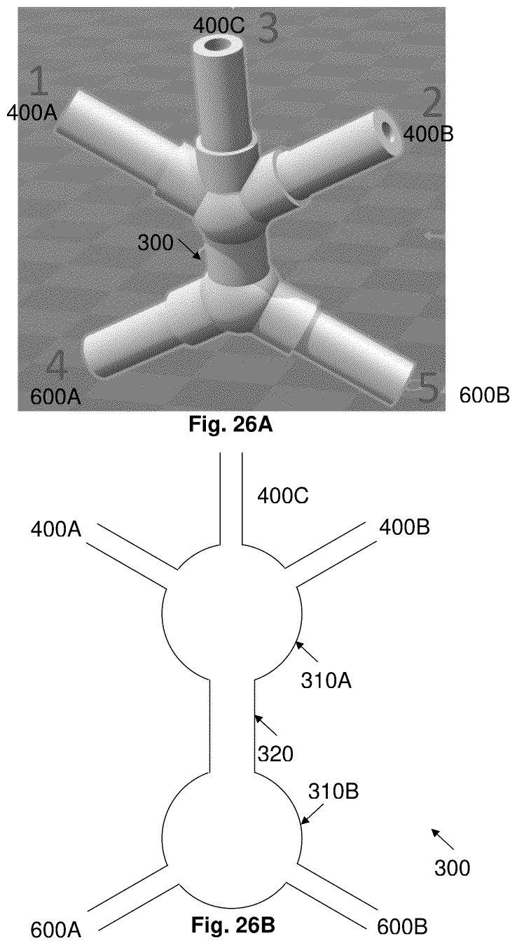

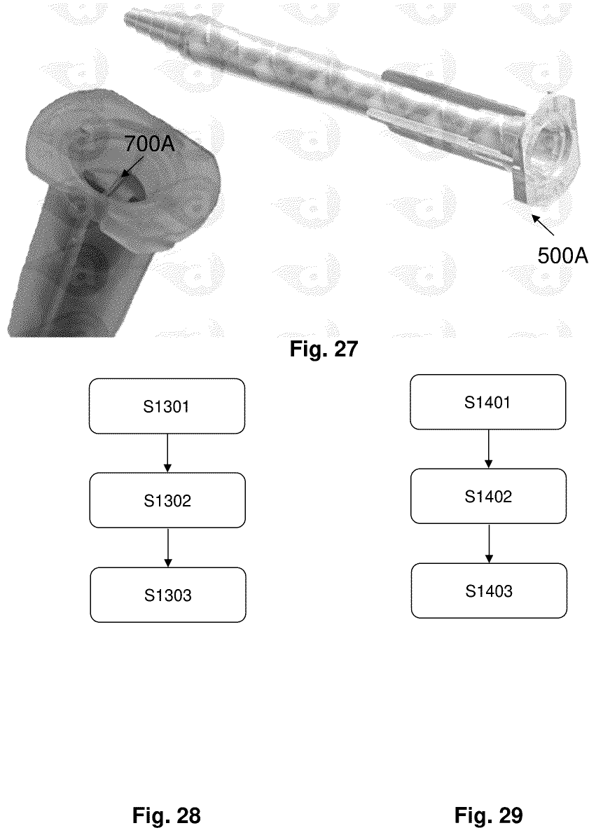

FIG. 27 is a photograph (perspective view) of a deposition nozzle of the deposition apparatus of the vehicle of FIGS. 19A and 19B. The deposition nozzle is a static mixing nozzle (MA6.3-21S, Adhesive Dispensing Ltd, UK). In more detail, the deposition nozzle is a bayonet inlet, helical static mixer nozzle, conventionally for 50 ml and 75 ml dual component cartridges. Stepped outlet that can be cut back to increase orifice size and increase flow rates. These mixer nozzles are suitable for all two-component materials. They have white elements and are constructed of high grade polypropylene. High quality mixer nozzles for use with twin cartridges. 6.3 mm ID×21 mixing elements. Use with 50 ml 1:1 and 2:1 ratio bayonet style dual cartridges. Part ID: MA6.3-21S. Material: Polypropylene. Colour: Natural Outer, White Elements. Inner Diameter: 6.3 mm. Outer Diameter: 9 mm. Length: 153 mm. Tip Outlet: 1.5 mm. Elements: 21. Retained Volume: 3.6 ml. Details: Industrial grade, Silicone Free.

Summary of Experimental Results

A summary of the experimental results is reported in Table 3, showing that the proposed PU foam depositing system enables the rover to overcome obstacles which were previously insurmountable. In all cases, the volumetric expansion ratio was between 29× and 32×, showing the robust control over the mixing process and, hence, the final mechanical properties of the foam. These values also prove that conservative estimates were attained during characterisation for expansion, this was ascertained to be due to free rise expansion being larger than controlled expansion in a measuring beaker. Survival rates of trapped victims within collapsed buildings depends entirely on the circumstance, with major trauma and suffocation typically killing within hours. A depositing system that can enable a robotic platform to access these areas within minutes is suitable.

TABLE 3
Summary of experimental results, where H = Height, D =
Depth, L = Length and Vol = Volume.

| | Test One | Test Two | Test Three |
|---|---|---|---|
| Type | Small Frontal | Large Frontal | Chasm |
| Dimensions (mm) | H: 60 | H: 130 | D × L: 100 × 200 |
| Deposit Vol (cm³) | 2000 | 5000 | 4000 |
| PU used (cm³) | 63 | 170 | 126 |
| Run time | 6 mins | 13 mins | 5 mins |
| | 42 secs | 42 secs | 50 secs |

Method of Controlling a Vehicle

FIG. 28 schematically depicts a method of controlling a vehicle to deposit a foam comprising a polymeric composition according to an exemplary embodiment.

At S1301, a first component and a second component of the polymeric composition are blended, using a blending chamber, to provide a precursor of the polymeric composition.

At S1302, the foam is generated, at least in part, by mixing, using a static mixer included in a first deposition nozzle, the precursor.

At S1303, the foam is deposited, at least in part, via the first deposition nozzle.

The method may comprise any of the steps described herein.

Method of Depositing a Foam

FIG. 29 schematically depicts a method of depositing a foam comprising a polymeric composition according to an exemplary embodiment.

At S1401, a first component and a second component of the polymeric composition are blended, using a blending chamber, to provide a precursor of the polymeric composition.

At S1402, the foam is generated, at least in part, by mixing, using a static mixer included in a first deposition nozzle, the precursor.

At S1403, the foam is deposited, at least in part, via the first deposition nozzle.

The method may comprise any of the steps described herein.

Vehicle

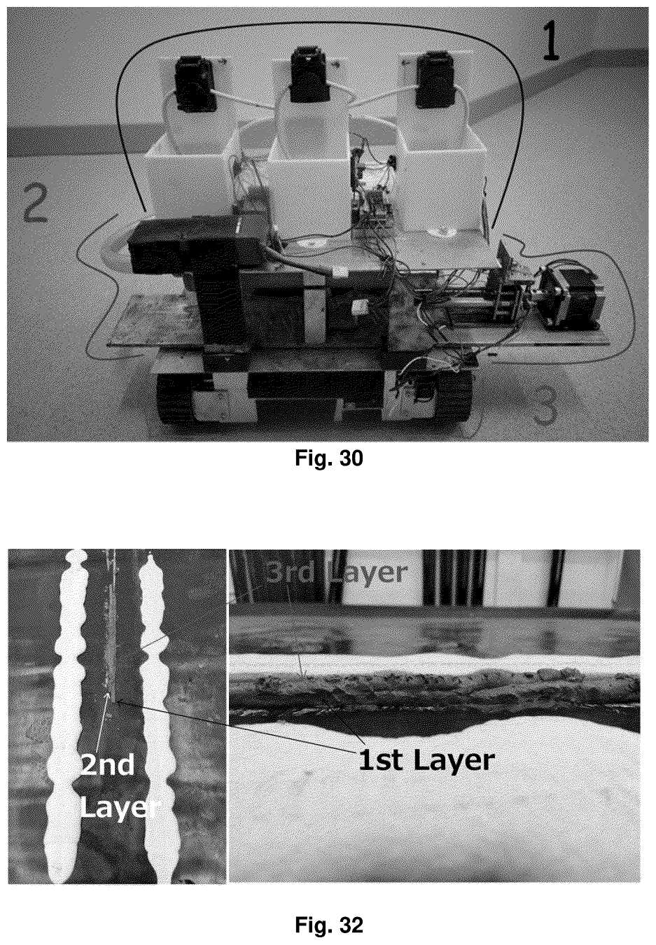

FIG. 30 is a photograph of a vehicle 5 according to an exemplary embodiment: Image of fully integrated platform: 1) Foam deposition system, 2) Cement deposition module, 3) base tracked mobile vehicle.

The final stage of integration was the implementation of the support material mechanism with the already integrated path following and deposition system. An image of the fully integrated system is shown in FIG. 30. The entire system was controlled by one central Arduino board, connected to all subsystems via an 12C protocol. The system had a total weight, when fully loaded of around 25 kg and a total height of 550 mm. This total system weight corresponded to a total ground pressure of 0.0136 MPa, based on the total ground contact of the two tracks of length and width 300 mm and 30 mm, respectively. Two demonstrations were conducted to assess the integrated systems ability to print multi-layered structures. The first considered printing while following a square path, similar to that followed in the previous section, where one side consisted of multiple deposit commands. The second simply retraced a straight line multiple times, with several deposit commands along this line. Both tests were designed to assess the system's ability to accurately follow predetermined paths, deposit sufficient support material to allow height increase and subsequent layer printing, deposit cementitious material in the correct locations, and ability to climb on to the support material to allow printing of subsequent layers using both the localisation and visual-servoing systems. The integrated system was programmed to follow a series of waypoints, where commands were provided at each waypoint. The exact waypoint location is irrelevant for the purposes of assessing these demonstrations, as the only requirement for the system was to consistently follow the same path. In fact, re-tracing the same path enabled the rover to climb on the previously deposited support and the visual-servoing system to deposit material on top of previous layers.

Square Path-Line Print

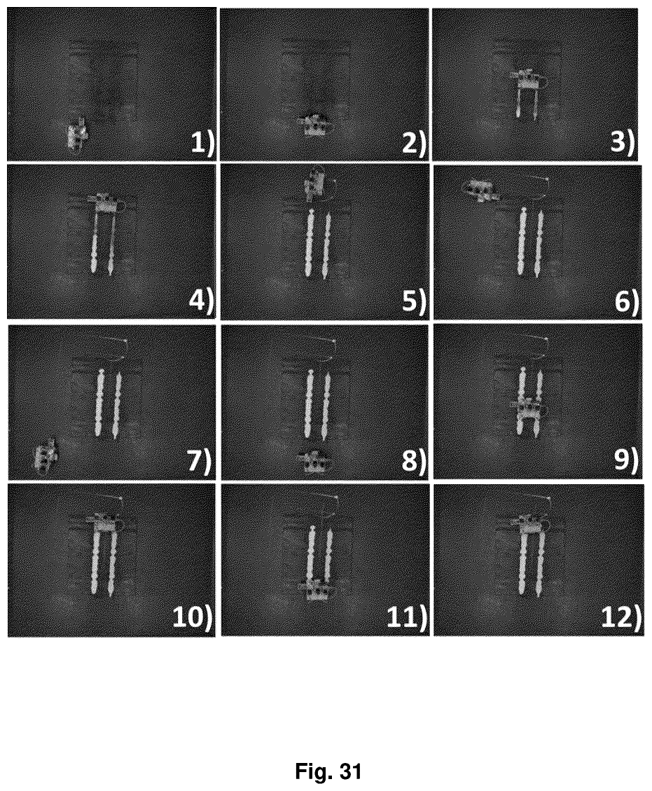

For this first integrated demonstration, the system was given a series of 15 (X, Y) waypoints, in the outline of a square. The system was tasked with carrying out the following instruction for each waypoint respectively: 1-2) Re-orientate and travel to next waypoint, 3) Initiate support deposition, 4) Initiate cementitious extrusion, 5) Cease cementitious extrusion, 6) Cease support deposition, 7-9) Re-orientate and travel to next waypoint, 10) Re-orientate and travel to next waypoint and wait for support curing, initialise visual-servoing system to detect previous layer and control extrusion initiation, 11-13) Re-orientate and travel to next waypoint, 14) Re-orientate and travel to next waypoint and wait for support curing, initialise visual-servoing system to detect previous layer and control extrusion initiation, 15) Stop system. The system contained sufficient cementitious material for three layers, the first deposition was programmed to initiate for 500 mm and subsequent layers were programmed to deposit upon pre-deposition detection, theoretically resulting in similar deposit lengths. The total run time for this demonstration was approximately 23 minutes and the total path length was around 25 m. Aerial snapshots of the test are shown in FIG. 31. Firstly, these images highlight the system ability to robustly follow the same path, as the rover remounted the foam twice upon returning from other waypoints. Secondly, the foam supports were accurately deposited to ensure that the rover could remount and increase altitude in the correct location utilising them. Three sets of cementitious deposit and two support deposits were created, as shown in FIG. 32. The support structures were 1300 mm long, 110 mm wide and 14 mm high on average. These values fluctuated, due to the extremely uneven flooring resulting in a pooling effect in areas. This could be compensated for by increasing flow velocity to ensure less fluid-like output, as described in previously. As for the cementitious depositions, it can be seen that a two layer deposition was created. The first deposition was 530 mm long, this 30 mm over extrusion highlighted a small delay between pump extrusion ceasing and material output actually stopping.

The second deposition was 510 mm long and started 70 mm after the initial deposition. This was determined to be due to a delay from detection of the previous deposit to the extrusion output, which was around ¾s. The visual-servoing system had detected the previous deposition and accurately positioned the outlet to deposit over it for the first 30 mm of output. However, after this point the high contrast filtering meant one side of the deposition was not fully detected and the outlet was therefore positioned slightly to the left, which resulted in the entire deposition falling to one side. The third and final deposition was 280 mm long and started 160 mm after the initial deposition. The larger surface area of concrete provided by the two side by side depositions meant that detection was more robust. The visual-servoing system successfully detected the now larger two part extrusion and deposited accurately atop and between them as shown. The decreased amount of cementitious output was later discovered to be due to a system blockage, that occurred as a result of compacting for the final 20% of material.

Straight Line-Line Print

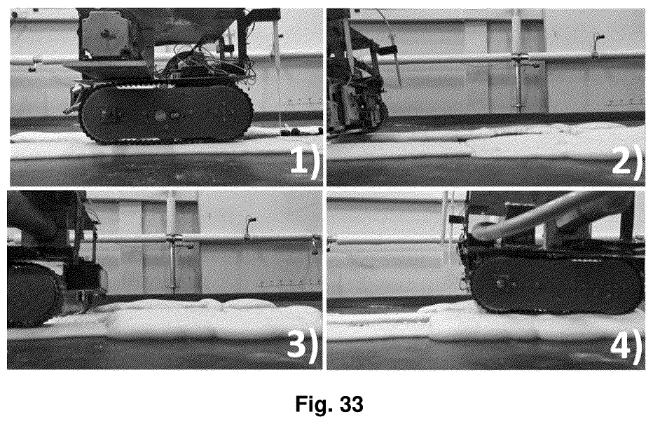

The printing strategies for this test were identical to the previous demonstration, but the path following procedure involved a less complex route as this had already been validated. The support material pump rate was increased to ensure a more viscous output to mitigate the pooling effect in the last demonstration. Also, the initial extrusion layer was programmed to stop 20 mm before the goal tolerance for the first layer, to account for the 2 s output delay discussed in the last demonstration. For this demonstration the system was given a series of 6 (X, Y) points along a straight line. The system was tasked with carrying out the following instructions for each waypoint respectively: 1) Initiate support deposition, 2) Initiate cementitious extrusion, 3) Stop cementitious extrusion, 4) Stop support deposition, 5-6) Re-orientate and travel to next waypoint and wait for support curing, initialise visual-servoing system to detect previous layer and control extrusion initiation, The system contained sufficient cementitious material for three layers, the first deposition was programmed to initiate for 400 mm and subsequent layers were programmed to deposit upon detection, theoretically resulting in similar lengths. Total distance travelled during this demonstration was approximately 6 m and total run time was 13 minutes. The support ramps were extremely consistent and measured: 950 mm in length, 135 mm in width and varied from 15 mm at the ends to 20 mm in the centre. Again this demonstration highlighted the system's ability to path follow, as the system moves between the same points consistently and travels successfully over the support structures and pre-depositions. As with the first demonstration, three sets of cementitious extrusion were created. The results reflect those described in the last section. It can be seen that a two layer deposition was created. Examination showed that the first deposition was 390 mm long, validating the hypothesis that first layer printing needs to be ceased before reaching the goal tolerance. The second deposition was 400 mm long and started 80 mm after the initial deposition, further justifying the systematic delay between detection and deposition. Once again, the visual-servoing system deposited the second deposition to the left of the first. However, unlike the last demonstration it correctly stacked a small amount at the end of the first deposit. The third and final deposition was 210 mm long and started 20 mm after the initial deposition. The visual-servoing system successfully detected the larger two-part extrusion and deposited accurately atop and between them. At this stage the system had used up its cement supply, but still had a large amount of PUF material left, a benefit of using expansive material based around peristaltic pumping. The system was therefore reprogrammed to follow the previous line of extrusion to deposit PUF, if and when pre-deposited cement was detected, the result should have created a two tier support system for further printing. As shown in FIG. 33, the visual system successfully detected the pre-deposit to initiate PUF deposition on the previous ramp. These images also highlight the systems accuracy in detecting the end of any cementitious deposit with the pre-expanded foam ending almost exactly at the end of the visible cement, shown in FIG. 33.2. The system then waited for foam to cure, before reorienting and travelling over the newly created second support tier. The second tier successfully supported the system and allowed an increase in altitude of 55 mm in total. At this stage, the system would print further layer of cementitious materials and so, the process would continue. This demonstration highlighted the need for a linear actuator to compensate for over/under expansion in foam. The first layer of this demonstration printed to a height varying from 15-20 mm, whilst the second layer expanded to a height of around 25-35 mm.

Notes

Attention is directed to all papers and documents which are filed concurrently with or previous to this specification in connection with this application and which are open to public inspection with this specification, and the contents of all such papers and documents are incorporated herein by reference. All of the features disclosed in this specification (including any accompanying claims and drawings), and/or all of the steps of any method or process so disclosed, may be combined in any combination, except combinations where at most some of such features and/or steps are mutually exclusive. Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. A vehicle, preferably an unmanned and/or autonomous vehicle, for example a robot, the vehicle comprising:
a propulsion system, arranged to propel the vehicle on a surface, comprising a set of wheels including a first wheel and/or a set of tracks including a first track;
a set of sensors, including a first sensor, arranged to sense a first deposition target of a set of deposition targets in the surface and to transmit a first signal, in response to sensing the first deposition target;
a deposition apparatus for depositing a material on and/or in the first deposition target; and
a controller arranged to receive the first signal transmitted by the first sensor and to control the propulsion system and/or the deposition apparatus, based, at least in part, on the received first signal.

2. The vehicle according to claim 1, wherein the deposition apparatus comprises:
a set of reservoirs, including a first reservoir, arranged to receive the material therein;
a set of deposition nozzles, including a first deposition nozzle, in fluid communication with the set of reservoirs via a set of outlet passageways including a first outlet passageway; and
a set of extruders, including a first extruder, arranged to urge at least some of the material received in the set of reservoirs through the set of deposition nozzles.

3. The vehicle according to claim 1, wherein the first extruder comprises and/or is a piston extruder or a screw extruder.

4. The vehicle according to claim 1, wherein the first deposition nozzle is arranged rearwardly of the first sensor.

5. The vehicle according to claim 1, wherein the controller is arranged to control the propulsion system to move the vehicle and to control the deposition apparatus to deposit at least some of the material on and/or in the first deposition target, based, at least in part, on the received first signal, while the vehicle is moving.

6. The vehicle according to claim 1, wherein the controller is arranged to control the propulsion system to follow the first deposition target, based, at least in part, on the received first signal.

7. The vehicle according to claim 6, wherein the controller is arranged to control the deposition apparatus to deposit at least some of the material on and/or in the first deposition target, based, at least in part, on the received first signal, while the vehicle is following the first deposition target.

8. The vehicle according to claim 7, wherein the controller is arranged to control the deposition apparatus to repeatedly deposit at least some of the material on and/or in the first deposition target, based, at least in part, on the received first signal.

9. The vehicle according to claim 1, wherein the first sensor comprises and/or is an optical sensor, for example an imager or a laser scanner.

10. The vehicle according to claim 1, wherein the controller is arranged to determine a first dimension of the first deposition target, based, at least in part, on the received first signal.

11. The vehicle according to claim 1, wherein the controller is arranged to control the deposition apparatus to deposit at least some of the material on and/or in the first deposition target, based, at least in part, on the determined first dimension.

12. The vehicle according to claim 1, comprising a transmitter, wherein the controller is arranged to control the transmitter to transmit information relating to the set of deposition targets.

13. The vehicle according to claim 1, wherein the set of sensors is arranged to sense the first deposition target after depositing the material therein and/or thereon.

14. The vehicle according to claim 1, comprising a machine tool arranged to machine the surface to redefine, at least in part, the first deposition target.

15. The vehicle according to claim 1, comprising a cleaner, for example an air blower apparatus, a sweeper apparatus and/or a vacuum apparatus, arranged to remove debris from the first deposition target.

16. The vehicle according to claim 1, comprising a compactor arranged to compact the deposited material in and/or on the first deposition target.

17. The vehicle according to claim 1, comprising a second deposition apparatus for depositing a foam comprising a polymeric composition and wherein the controller is arranged to control the second deposition apparatus;
wherein the second deposition apparatus comprises:
a set of reservoirs, including a first reservoir and a second reservoir arranged to receive therein a first component and a second component of the polymeric composition, respectively;
a set of pumps, including a first pump and a second pump arranged to pump the first component and the second component from the first reservoir and the second reservoir, respectively;
a blending chamber in fluid communication with the set of reservoirs via a set of inlet passageways, including a first inlet passageway and a second inlet passageway, wherein the blending chamber is arranged to blend the first component and the second component therein to provide a precursor of the polymeric composition; and
a set of deposition nozzles in fluid communication with the blending chamber via a set of outlet passageways including a first outlet passageway, the set of deposition nozzles including a first deposition nozzle comprising a static mixer arranged to mix the precursor to generate the foam, at least in part, therefrom.

18. A method of controlling a vehicle according to claim 1 to sense deposition targets and to deposit a material thereon and/or therein, the method comprising:
sensing a first deposition target of a set of deposition targets and transmitting a first signal, in response to sensing the first deposition target;
controlling the propulsion system, based, at least in part, on the received first signal; and
depositing at least some of the material on and/or in the first deposition target, based, at least in part, on the received first signal.

19. The method according to claim 18, wherein the material comprises a slurry comprising asphalt or cement.

20. The method according to claim 18, when dependent on claim 17, wherein the method comprises:
blending, using the blending chamber, the first component and the second component of the polymeric composition to provide the precursor of the polymeric composition;
generating the foam, at least in part, by mixing, using the static mixer included in the first deposition nozzle, the precursor; and
depositing the foam, at least in part, via the first deposition nozzle.

21. The method according to claim 20, comprising depositing the foam, at least in part, via the first deposition nozzle on and/or in the first deposition target, based, at least in part, on the received first signal.

22. The method according to claim 21, comprising depositing at least some of the material on and/or in the deposited foam and/or in the first deposition target, based, at least in part, on the received first signal.

23. A method of remediating damage, such as a crack or a pothole, to a thoroughfare, according to claim 18.
